(19) United States
(12) Patent Application Publication
(10) Pub. No.: US 2015/0354323 A1
(43) Pub. Date: Dec. 10, 2015

(54) NON-ALKYL PYRIDINE SOUR CORROSION INHIBITORS AND METHODS FOR MAKING AND USING SAME

(71) Applicant: CLEARWATER INTERNATIONAL, LLC, Houston, TX (US)

(72) Inventors: Duane Treybig, Houston, TX (US); Pulikesi Murugan, Houston, TX (US); Simon Levey, Edmonton (CA)

(21) Appl. No.: 14/301,247

(22) Filed: Jun. 10, 2014

(51) Int. Cl. E21B 41/02; E21B 7/00; E21B 21/00; C09K 8/035

(52) U.S. Cl. CPC E21B 41/02; C09K 8/035; E21B 7/00; E21B 21/00; C09K 2208/32; C09K 2208/20

(57) ABSTRACT

Corrosion inhibiting compositions include at least one dialkyl sulfate quaternary salt of 1,2-disubstituted imidazolines and may include dialkyl sulfate quaternary salts of 1,2-disubstituted imidazoline amides, amides of polyamines, and/or polyamines, and an intensifier system in the presence or absence of a solvent system and methods for making and using same.

### BACKGROUND OF THE INVENTION

1. Field of the Invention

Embodiments of the present invention relates to compositions including non-pyridine compounds for sour material inhibitors and methods for making and using same.

More particularly, embodiments of the present invention relates to compositions including non-pyridine compounds for sour material inhibitors, where the compositions include at least one dialkyl sulfate quaternary salt of 1,2-disubstituted imidazolines, 1,2-disubstituted imidazoline amides, bicyclic amines, amides of polyamines, and/or polyamines, and an intensifier system in the presence or absence of a solvent system.

2. Description of the Related Art

Currently most sour corrosion inhibitors are based on alkyl pyridine (AP) chemistries and typical treatment rates are from 500 ppm to 1000 ppm for high H₂S producing wells. Additives such as intensifiers and trans-cinnamaldehyde only improve alkyl pyridine quaternaries performance against corrosion at high pressure, temperature and strong acid according to U.S. Pat. No. 5,697,443 and Gema Cabello et. al. in Electrochimica Acta, Volume 97, pages 1-9. Since alkyl pyridine chemistry is obtained through the vitamin B industry as a waste stream, it would be beneficial to look at alternative chemistries that could be more effective.

Crude oil and natural gas can contain products such as hydrogen sulfide (H₂S), carbon dioxide (CO₂) and produced water which are extremely corrosive to the metal surfaces. H₂S is produced during the decomposition of organic material and occurs with hydrocarbons in some areas. As a consequence, H₂S can cause sulfide-stress corrosion cracking of metals. Because of its corrosiveness, H₂S production may require costly special production equipment such as stainless steel tubing; hence, the control of sour corrosion is a major concern in the oil and gas production arena. H₂S is a weak acid capable of donating two hydrogen ions in neutralization reactions forming HS⁻ and S²⁻ ions. In water, all three sulfide species, H₂S, HS⁻ ion, and S²⁻ ion are in dynamic equilibrium with water and H⁺ ions and OH⁻ ions. The percent distribution among the three sulfide species depends on pH.

Between 15% to 25% of natural gas in the U.S. may contain hydrogen sulfide, while worldwide, the figure could be as high as 30 percent. See, e.g., Georg Hammer, Torsten Lubcke, Roland Kettner, Mark R. Pillarella, Herta Recknagel, Axel Commichau, Hans-Joachim Neumann and Barbara Paczynska-Lahme “Natural Gas” in Ullmannn's Encyclopededia of Industrial Chemistry, 2006, Wiley-VCH, Weinheim, doi: 10.1002/14356007.a17_{—}073. A large number of sour gas wells are in the Middle East, Canada, Russia, Kazakhstan and China. See, e.g., Cor Verlaan and Gerald Vd Zwei. SPE 162167. Challenges and Opportunities in Sour Gas Development.” Nov. 11-14, 2012. Gas from some of Shell's projects contains 19% to 35% H₂S. See, e.g., Cor Verlaan and Gerald Vd Zwei. SPE 162167. Challenges and Opportunities in Sour Gas Development.” Nov. 11-14, 2012. Gas from one well in Canada is known to contain 90% hydrogen sulfide and others may have H₂S contents in the tens of percent range. See, e.g., Dalrymple, D. A., Skinner, F. D. and Meserole, N. P. 1991. Investigation of U.S. Natural Gas Reserve Demographics and Gas Treatment Processes. Topical Report, GRI-91/0019, Section 3.0, pp. 3-1 to 3-13. Gas Research Institute. And_Hugman, R. H., Springer, P. S. and Vidas, E. H. Chemical Composition of Discovered and Undiscovered Natural Gas in the United States: 1993 update. Topical Report, GRI-93/0456. P. 1-3. Gas Research Institute. As cited in Mclntush, K. E., Dalrymple, D. A. and Rueter, C. O. 2001. “New process fills technology gap in removing H₂S from gas,” World Oil, July, 2001. As a consequence, there is a need for corrosion inhibitors that provide protection against corrosion, especially in H₂S between 10% and 40% H₂S.

Hydrochloric acid, formic acid, acetic acid and hydrofluoric acid are used to stimulate oil and gas wells by acidizing carbonates and sandstone from 93.3° C. to 204.4° C. (200° F. to 400° F.). See, e.g., Salah Al-Harthy, Oscar A. Bustos, Mathew Samuel, John Still, Michael J. Fuller, Nurul Ezalina Hamzah, Mohd Isal Pudin bin Ismail, Arhtur Paraput. Oilfield Review. Winter 2008/2009: 20, No. 4. HCl is a strong acid. For example, the pH of 10% HCl is −0.5; the pH of 20% HCl is −0.8; the pH of 38% HCl is −1.1. Alkyl pyridine and quinoline quaternary salts are used to protect tubing from corrosion in HCl.

Protection of steel from H₂S and during acidizing sandstone and carbonates are two different applications. Corrosion inhibitors and their additive package may perform differently in different applications.

Alkyl pyridine based corrosion inhibitors, also do not provide the same corrosion protection over the entire temperature range varying from 50° C. to 120° C. (122° F. to 248° F.) in 35% H₂S and 4% CO₂. Finally, alkyl pyridine corrosion inhibitors are more effective in the oil/gas phase as compared to the water phase. Alkyl pyridine quaternaries formulated with surfactants have been used between 50° C. to 120° C. (122° F. to 248° F.) in 35% H₂S and 4% CO₂. When additives such as intensifiers and trans-cinnamaldehyde are added to the alkyl-pyridine quaternaries, corrosion protection is worse than the alkyl pyridine quaternaries only. Furthermore, treatment rates need to be lower than 500-1000 ppm. When treatment rates are 200 ppm, protection across the temperature range of 50° C. to 120° C. (122° F. to 248° F.) varies considerably; pitting is observed; and corrosion protection is only satisfactory in the oil/gas phase and not satisfactory in the water phase. U.S. Pat. No. 4,493,775 discloses the combination of acetophenone, paraformaldehyde, cyclohexylamine, tall oil and HCl provides protection in the presence of H₂S. U.S. Pat. No. 5,279,651 discloses that the combination of 2,4-diamino-6-mercapto pyrimidine sulfate and a meta-, ortho- and pyrovanadate provide protection in the presence of H₂S 2,4-diamino-6-mercapto pyrimidine sulfate is not soluble in water, alcohol or anything else.

Therefore, there is a need for a corrosion inhibitor for sour wells that works at treatment rates lower than 500 ppm to 1000 ppm, provides consistent or similar protection across the 50° C. to 120° C. (122° F. to 248° F.) temperature range, no pitting and that is as effective in the water phase as it is in the gas phase.

### SUMMARY OF THE INVENTION

Embodiments of the present invention provide low temperature hydrogen sulfide corrosion inhibitor compositions including a corrosion system and an intensifier system, where the corrosion systems include at least one dialkyl sulfate quaternary salt of 1,2-disubstituted imidazolines, 1,2-disubstituted imidazoline amides, bicyclic amines, amides of polyamines, and/or polyamines, and an intensifier system including in the presence or absence of a solvent system and the intensifier system include mixtures of ammonium iodide, iodine, water, t-cinnamaldehyde, and/or formic acid. In certain embodiments, the intensifier systems include mixtures of ammonium iodide, iodine, water, t-cinnamaldehyde, and formic acid.

Embodiments of the present invention provide methods for inhibiting hydrogen sulfide corrosion at low temperature including treating a surface with a composition including an effective amount of a corrosion inhibitor composition including a corrosion system and an intensifier system, where the corrosion systems include at least one dialkyl sulfate quaternary salt of 1,2-disubstituted imidazolines, 1,2-disubstituted imidazoline amides, bicyclic amines, amides of polyamines, and/or polyamines and an intensifier system including in the presence or absence of a solvent system and the intensifier systems include mixtures of ammonium iodide, iodine, water, t-cinnamaldehyde, and/or formic acid. In certain embodiments, the intensifier systems include mixtures of ammonium iodide, iodine, water, t-cinnamaldehyde, and formic acid.

Embodiments of the present invention provide downhole fluids for low temperature hydrogen sulfide corrosion inhibition including an effective amount of a composition including a corrosion system and an intensifier system, where the corrosion systems include at least one dialkyl sulfate quaternary salt of 1,2-disubstituted imidazolines, 1,2-disubstituted imidazoline amides, bicyclic amines, amides of polyamines, and/or polyamines and an intensifier system including in the presence or absence of a solvent system and the intensifier systems include mixtures of ammonium iodide, iodine, water, t-cinnamaldehyde, and/or formic acid. In certain embodiments, the intensifier systems include mixtures of ammonium iodide, iodine, water, t-cinnamaldehyde, and formic acid.

Embodiments of the present invention provide methods of drilling and producing including circulating a downhole fluid for low temperature hydrogen sulfide corrosion inhibition including an effective amount of a composition including a corrosion system and an intensifier system, where the corrosion systems include at least one dialkyl sulfate quaternary salt of 1,2-disubstituted imidazolines, 1,2-disubstituted imidazoline amides, bicyclic amines, amides of polyamines, and/or polyamines and an intensifier system including in the presence or absence of a solvent system and the intensifier systems include mixtures of ammonium iodide, iodine, water, t-cinnamaldehyde, and/or formic acid. In certain embodiments, the intensifier systems include mixtures of ammonium iodide, iodine, water, t-cinnamaldehyde, and formic acid.

### EXPERIMENTAL COMPOUND SUMMARIES USED IN DRAWINGS

Tabulated below are the designations and brief product descriptions for the corrosion inhibitors referenced in the figures:

| CI ID^{a} | Composition |
|---|---|
| E1 | reaction of product tall oil fatty acid and N-(2-aminoethyl)ethanolamine (AEEA) |
| | quaternized with diethyl sulfate |
| E2 | reaction of product tall oil fatty acid and A-1328 (a blend of 65 wt. % N-(2- |
| | aminoethyl)ethanolamine, 23 wt. % N-(2-aminoethyl)piperazine, 1.4 wt. % 5-ethyl- |
| | 1,4,7-triazabicyclo(4.3.0)non-4,6-diene, 0.8 wt. % 5-ethyl-1,4,7- |
| | triazabicyclo(4.3.0)non-6-ene and 10.2% triethylenetetramine) quaternized with diethyl sulfate |
| E3 | E1 plus an intensifier system including water, ammonium iodide, trans- |
| | cinnamaldehyde, and formic acid |
| E4 | E2 plus an intensifier system including water, ammonium iodide, trans- |
| | cinnamaldehyde, and formic acid |
| E5 | intensifier system including water, ammonium iodide, trans-cinnamaldehyde, and |
| | formic acid and a solvent system including isopropanol |
| E6 | E2 plus an intensifier system including water, trans-cinnamaldehyde, formic acid, and |
| | isopropanol |
| E7 | E2 plus an intensifier system including water, ammonium iodide, and formic acid |
| E8 | E2 plus an intensifier system including water, ammonium iodide, trans- |
| | cinnamaldehyde, and isopropanol |
| CE1 | reaction product of mixture of alkylated pyridines (Akolidine 10) and |
| | monoethanolamine quaternized with benzyl chloride and a solvent system including |
| | methanol |
| CE2 | reaction product of mixture of alkylated pyridines (Akolidine 10 and PAP-220) |
| | quaternized with benzyl chloride and a solvent system including methanol |
| CE3 | mixture of CE1 and CE2 and an intensifier system including ammonium iodide, DI |
| | water, trans-cinnamaldehyde, and formic acid. |
| CE4 | mixture of CE1 and CE2 and an intensifier system including ammonium iodide, DI |
| | water, trans-cinnamaldehyde, and formic acid and solvent system including C₁₂-C₁₅ |
| | ethoxylated alcohol |
| CE5 | mixture of CE1 and CE2 and an intensifier system including ammonium iodide, DI |
| | water, trans-cinnamaldehyde, and formic acid and solvent system including |
| | isopropanol, methanol, C₁₂-C₁₅ ethoxylated alcohol, diethylamine, QUATREX 182, |
| | and EC9541A |

^{a}Corrosion Inhibitor designation

### BRIEF DESCRIPTION OF THE DRAWINGS

The invention can be better understood with reference to the following detailed description together with the appended illustrative drawings in which like elements are numbered the same:

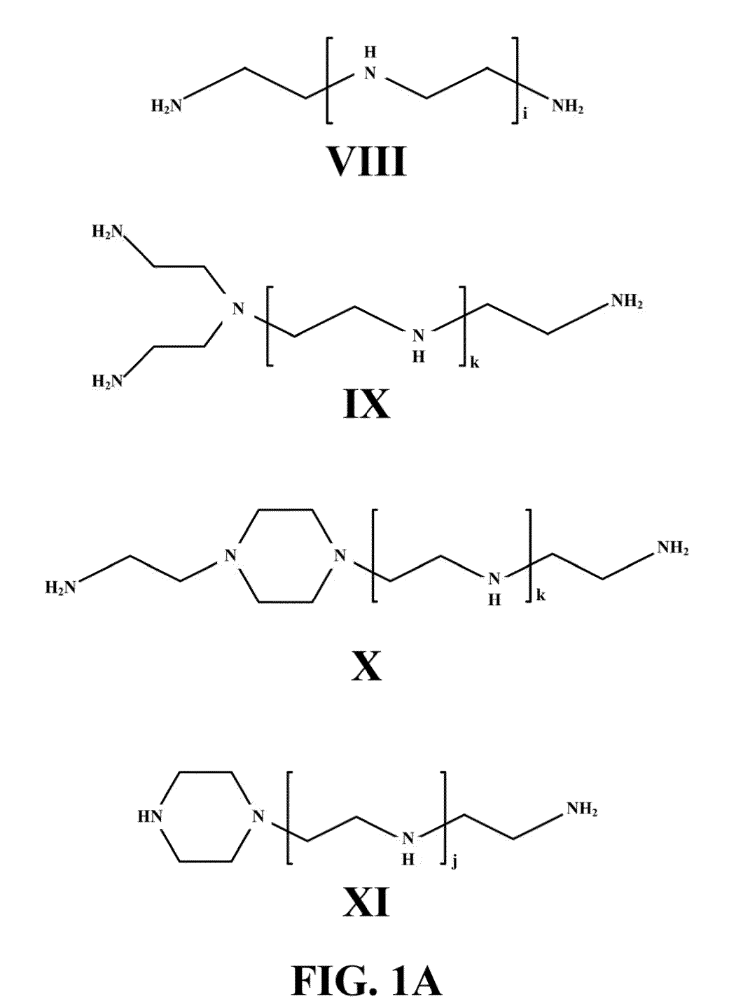

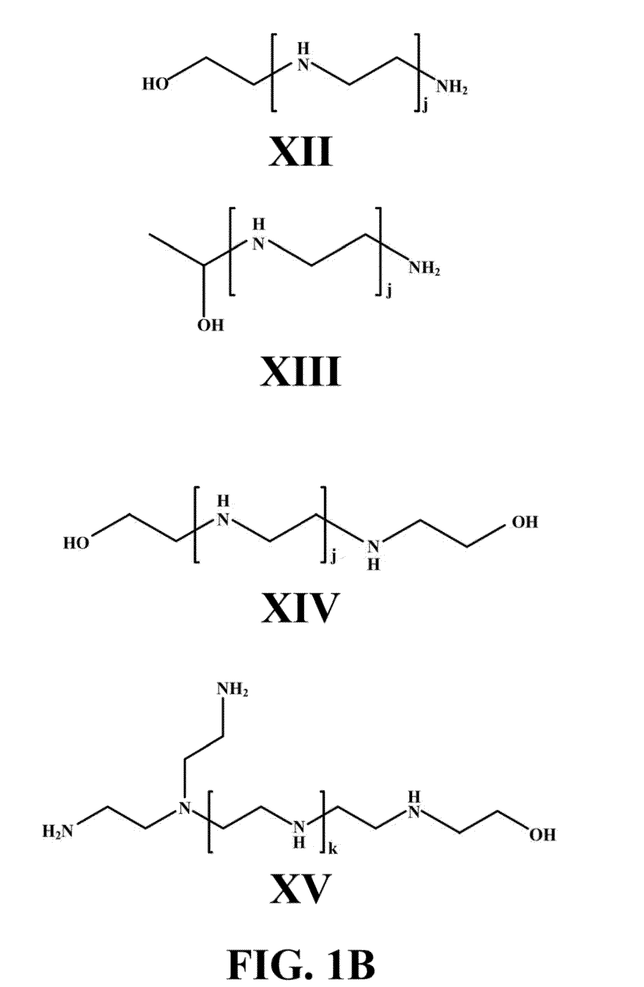

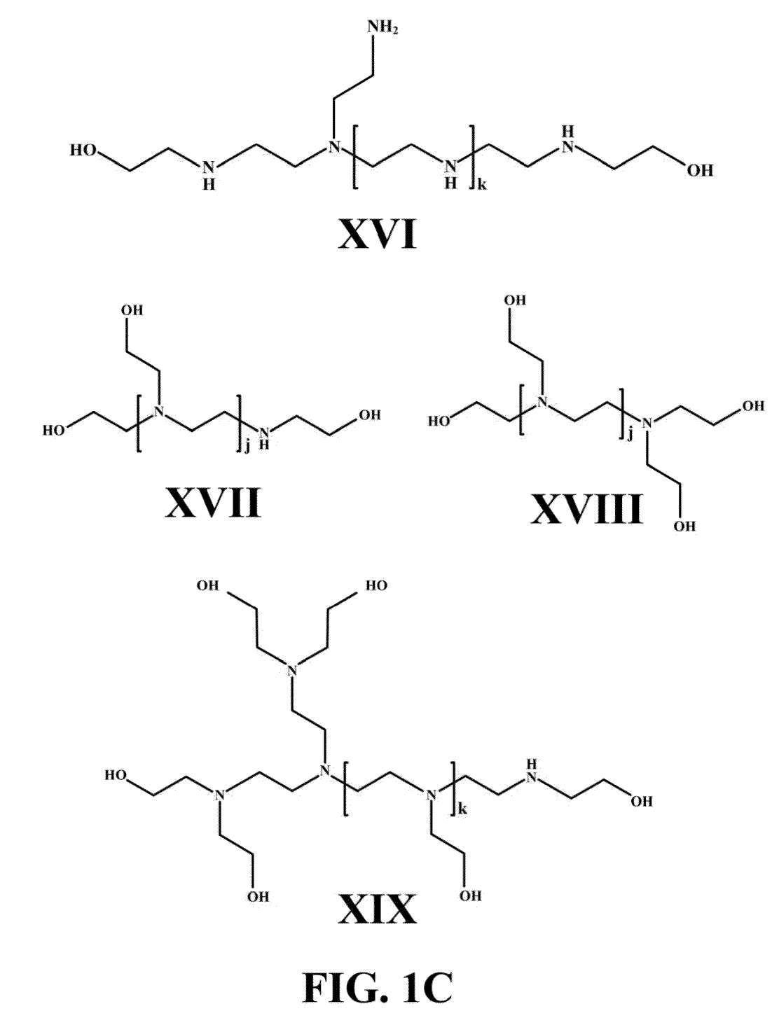

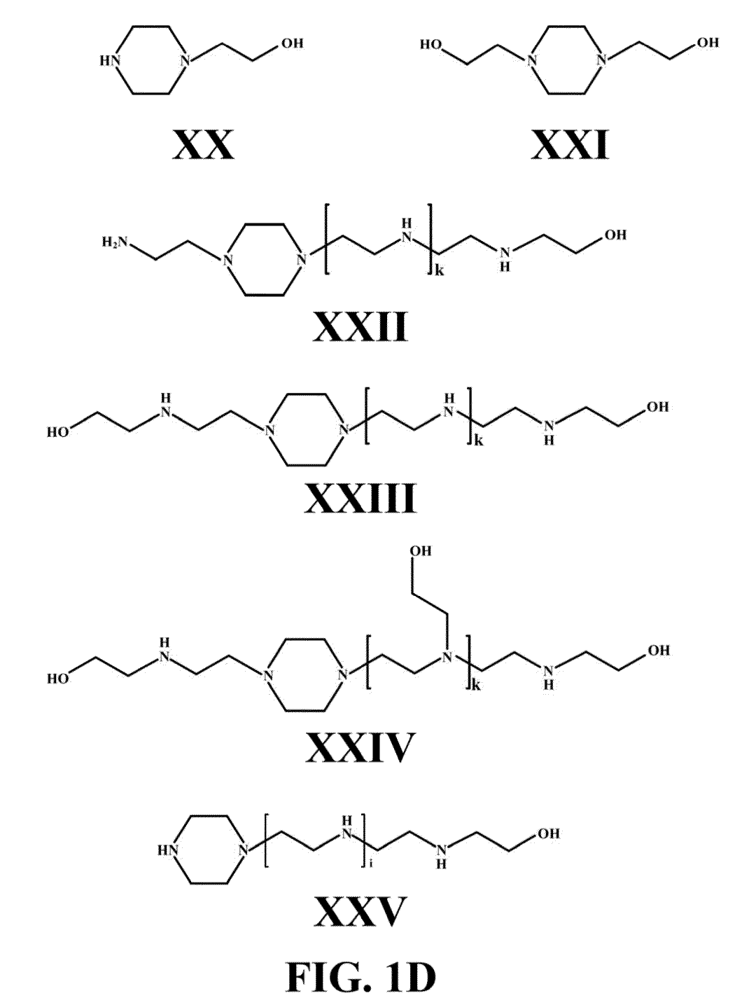

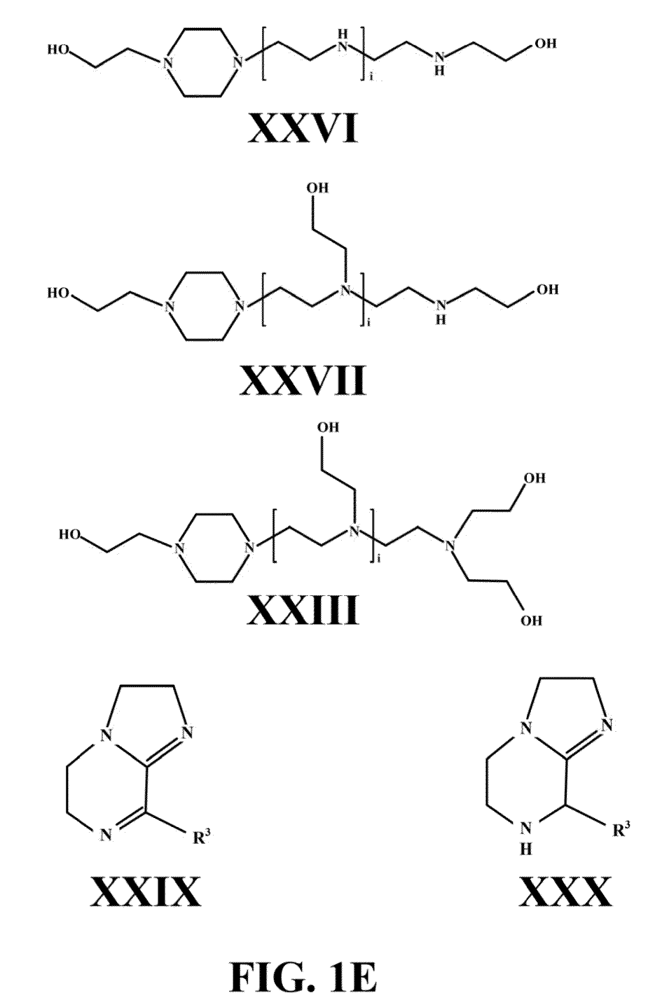

FIGS. 1A-E depict illustrative and non-limiting examples of amine structures some of which react with fatty acids to from 1,2-disubstituted imidazoline adducts of this invention, some of which are amidated, and some of which do not react with the fatty acids.

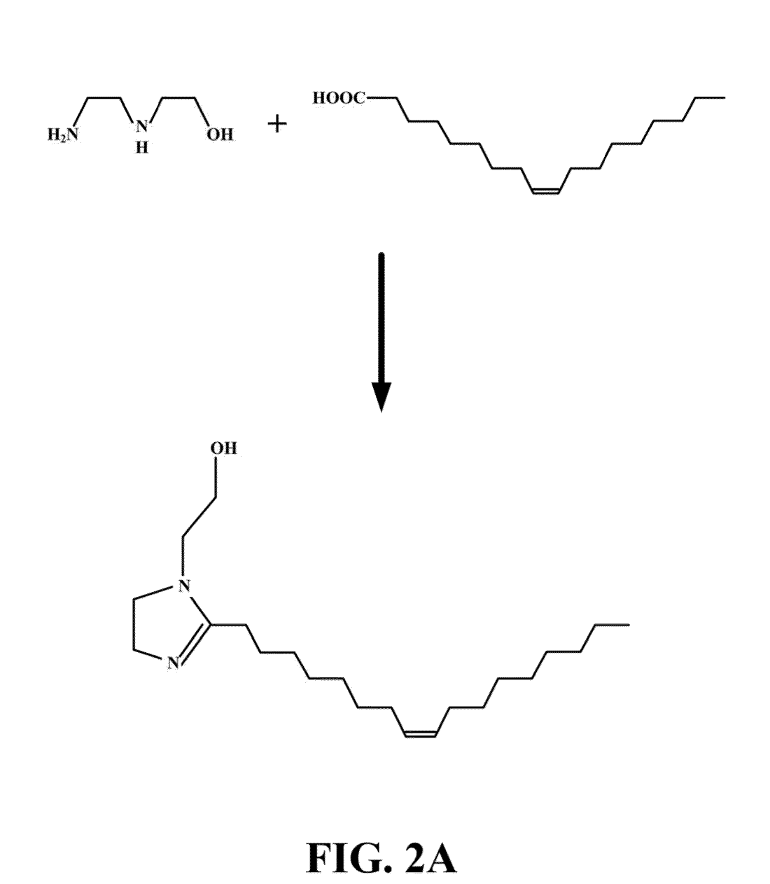

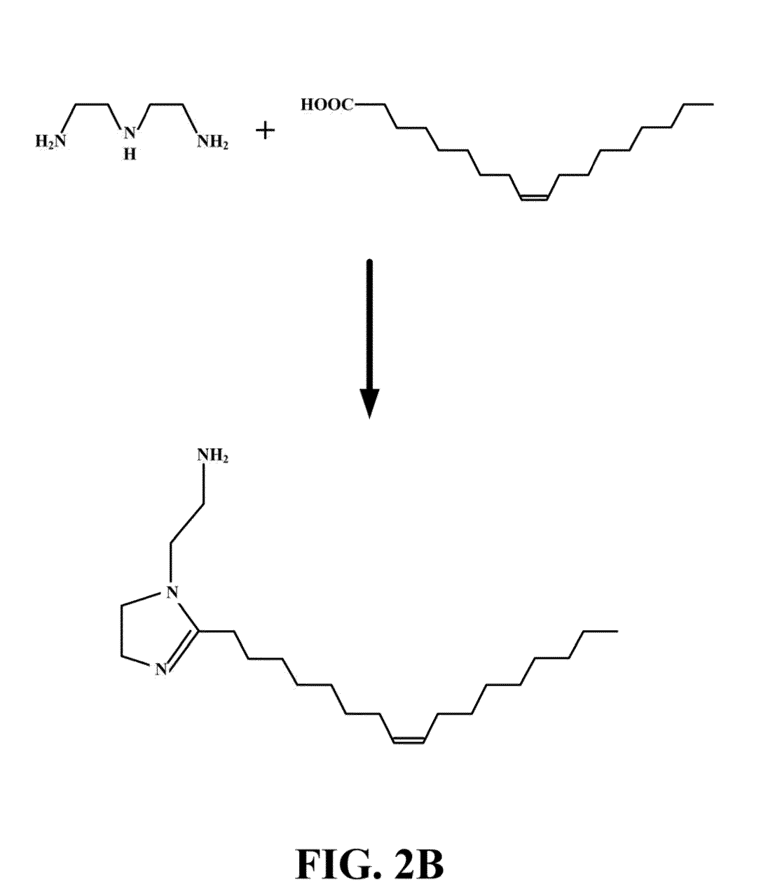

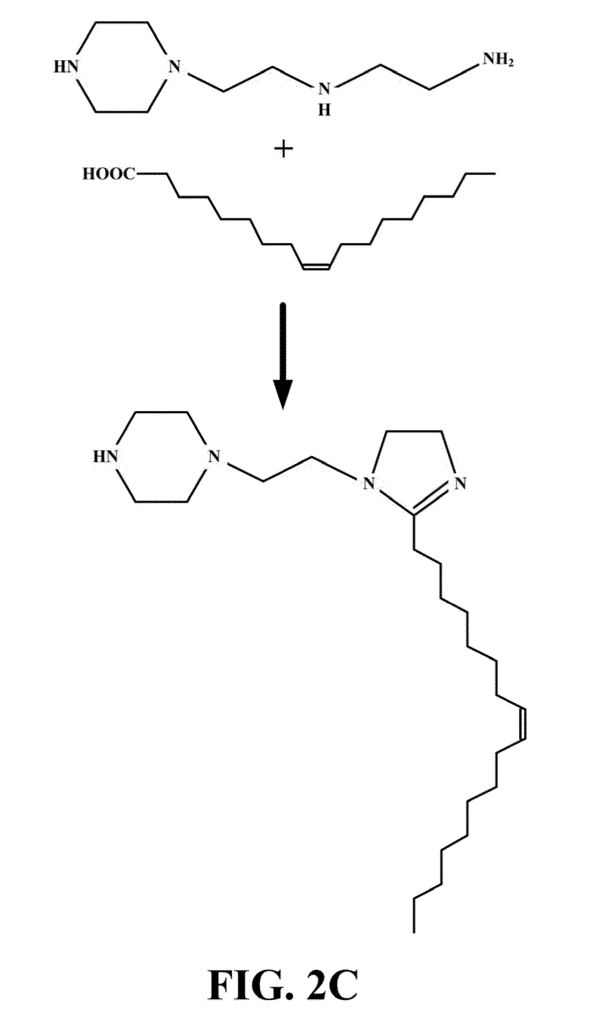

FIGS. 2A-C depict illustrative and non-limiting examples of reactions of this invention between amines and a fatty acid.

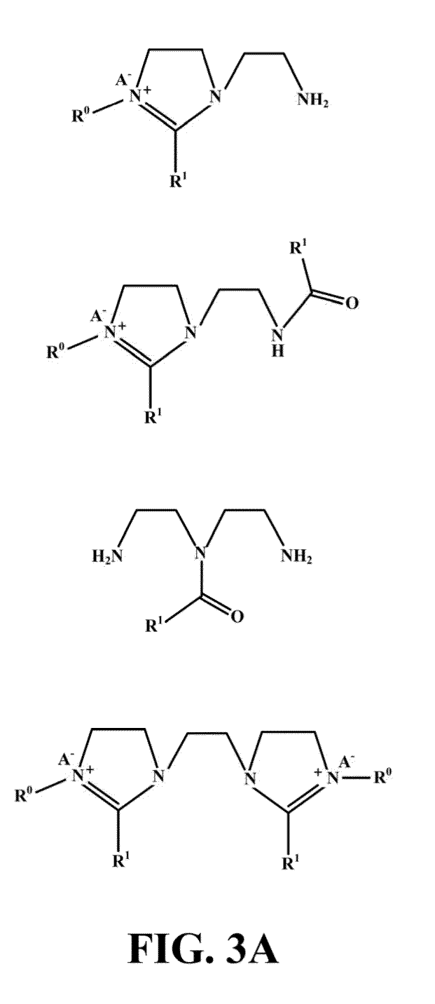

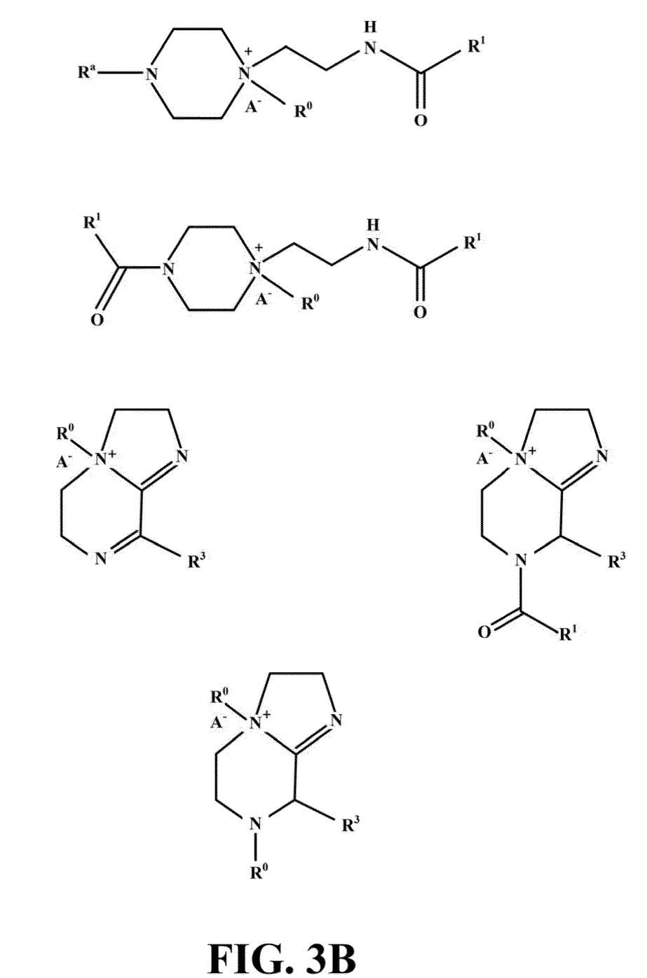

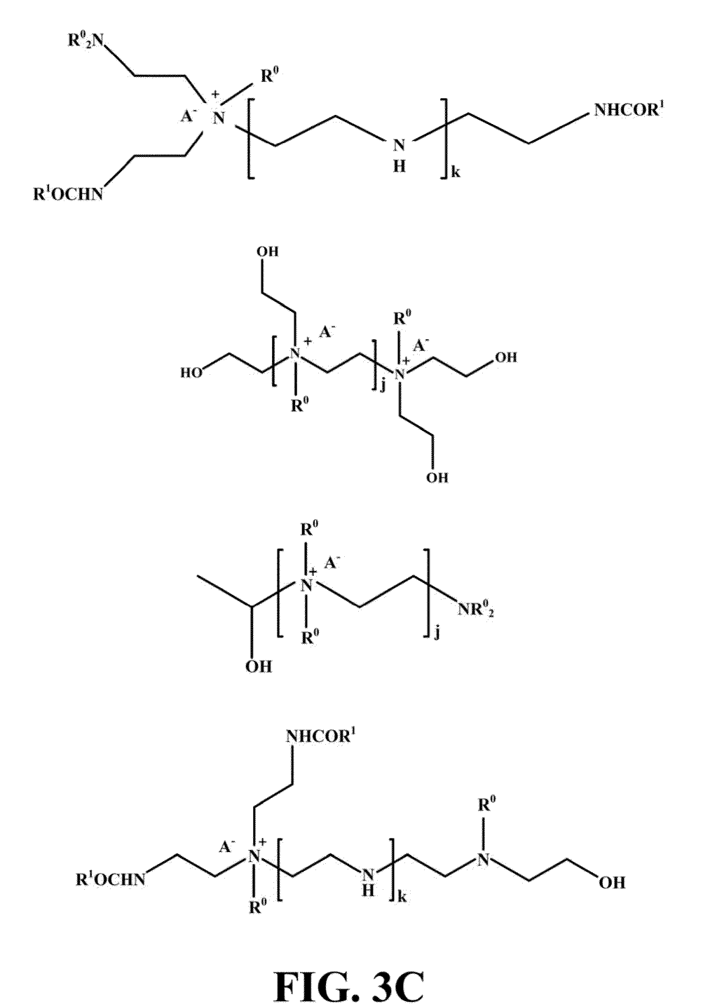

FIGS. 3A-C depict illustrative and non-limiting examples of quaternary corrosion inhibitors of this invention.

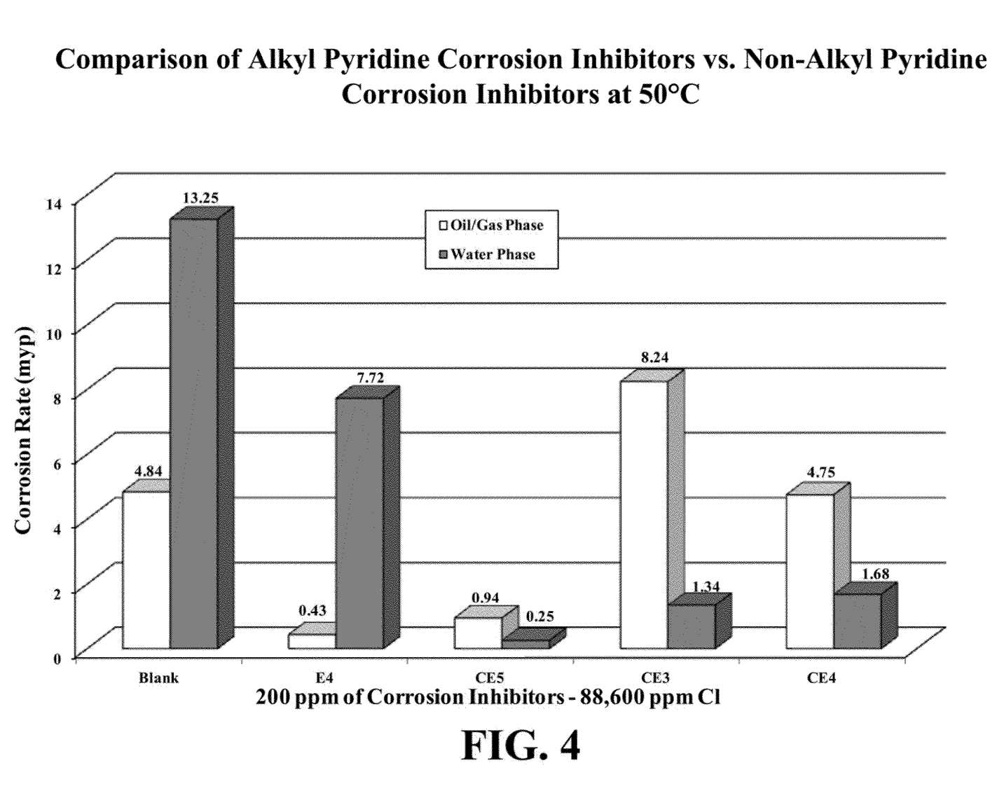

FIG. 4 depicts a comparison of 200 ppm of alkyl pyridine inhibitors CE3-CE5 vs. 200 ppm of a non-alkyl pyridine corrosion inhibitor E4 of this invention at 50° C. (122° F.) in a high salinity fluid (88,600 mg/L chloride).

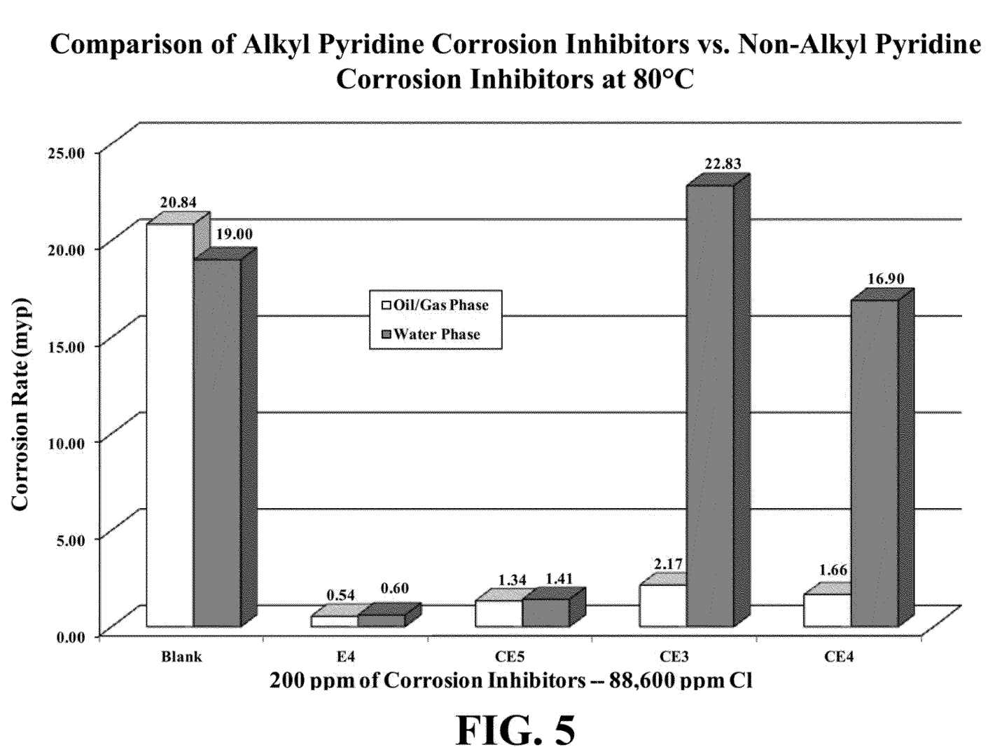

FIG. 5 depicts a comparison of 200 ppm of alkyl pyridine inhibitors CE3-CE5 vs. 200 ppm of a non-alkyl pyridine corrosion inhibitor E4 of this invention at 80° C. (176° F.) in a high salinity fluid (88,600 mg/L chloride).

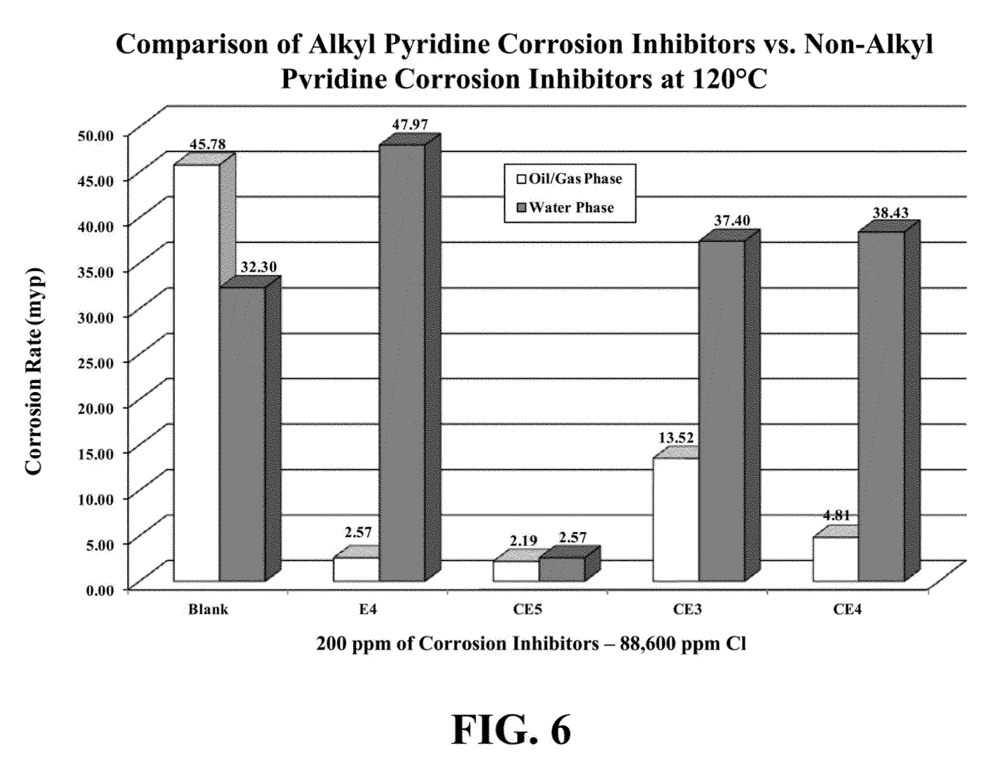

FIG. 6 depicts a comparison of 200 ppm of alkyl pyridine inhibitors CE3-CE5 vs. 200 ppm of a non-alkyl pyridine corrosion inhibitor E4 of this invention at 120° C. (248° F.) in a high salinity fluid (88,600 mg/L chloride).

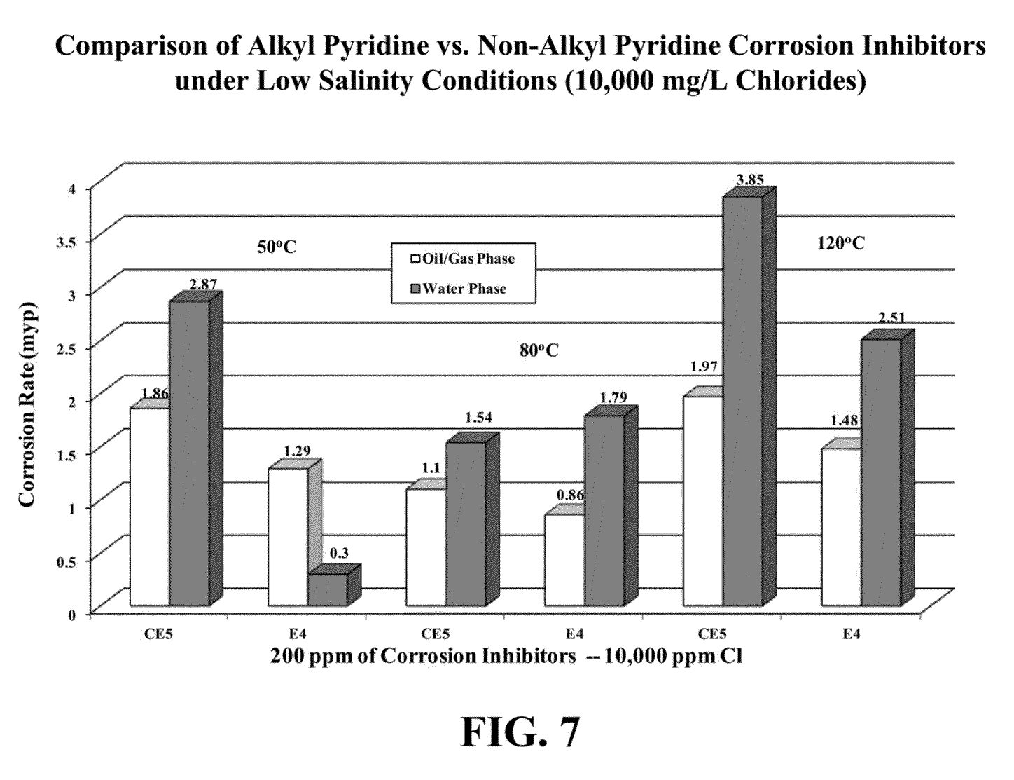

FIG. 7 depicts a comparison of an alkyl pyridine corrosion inhibitor CE5 vs. a non-alkyl pyridine corrosion inhibitor E4 of this invention in a low salinity fluid (10,000 mg/L chloride) at 50° C., 80° C., and 120° C.

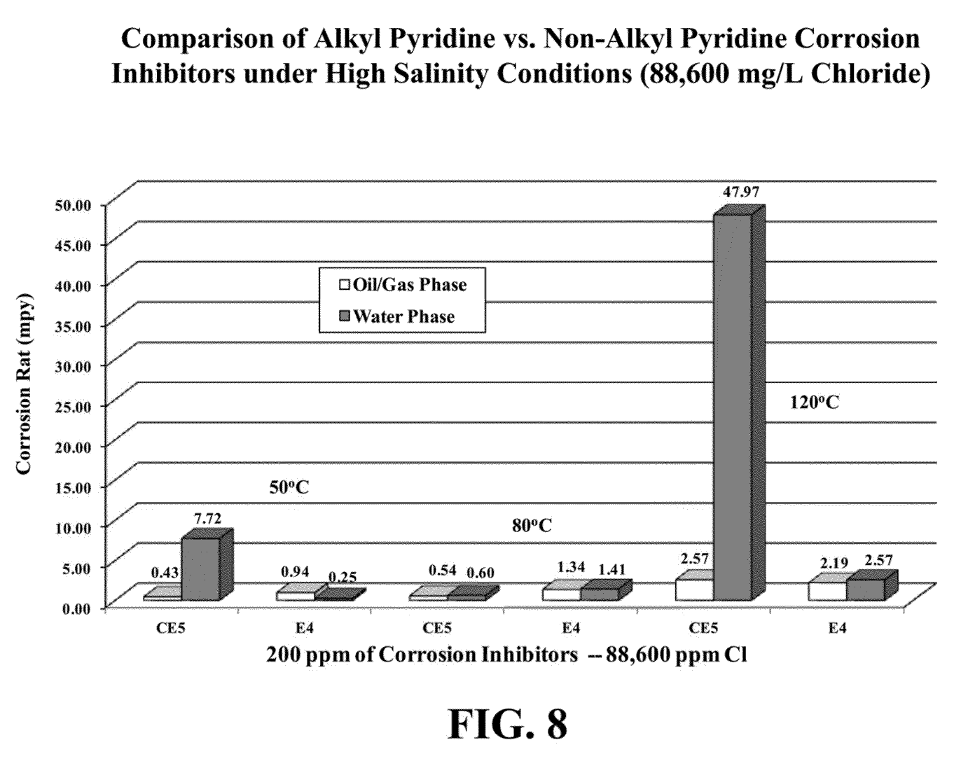

FIG. 8 depicts a comparison of oil/gas and water phase corrosion rates for an alkyl pyridine corrosion inhibitor CE5 vs. a non-alkyl pyridine corrosion inhibitor E4 of this invention in a high salinity fluid (88,600 mg/L chloride).

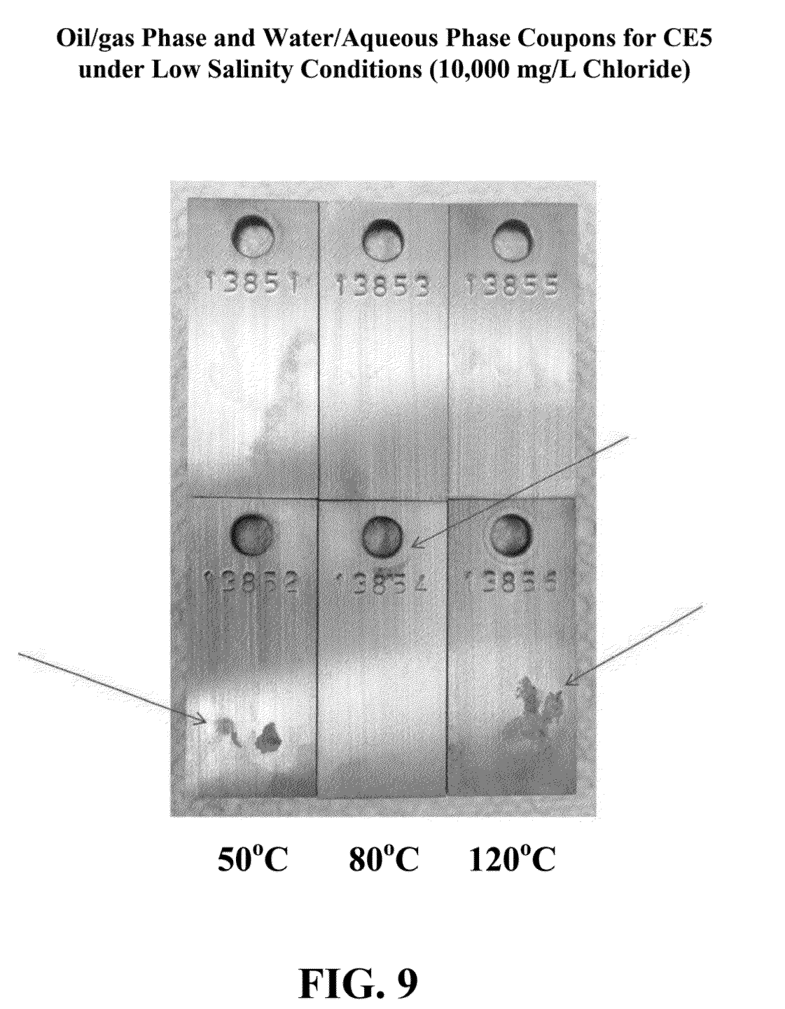

FIG. 9 depicts an oil/gas phase and water phase coupons from CE5 in a low salinity fluid (10,000 mg/L chloride).

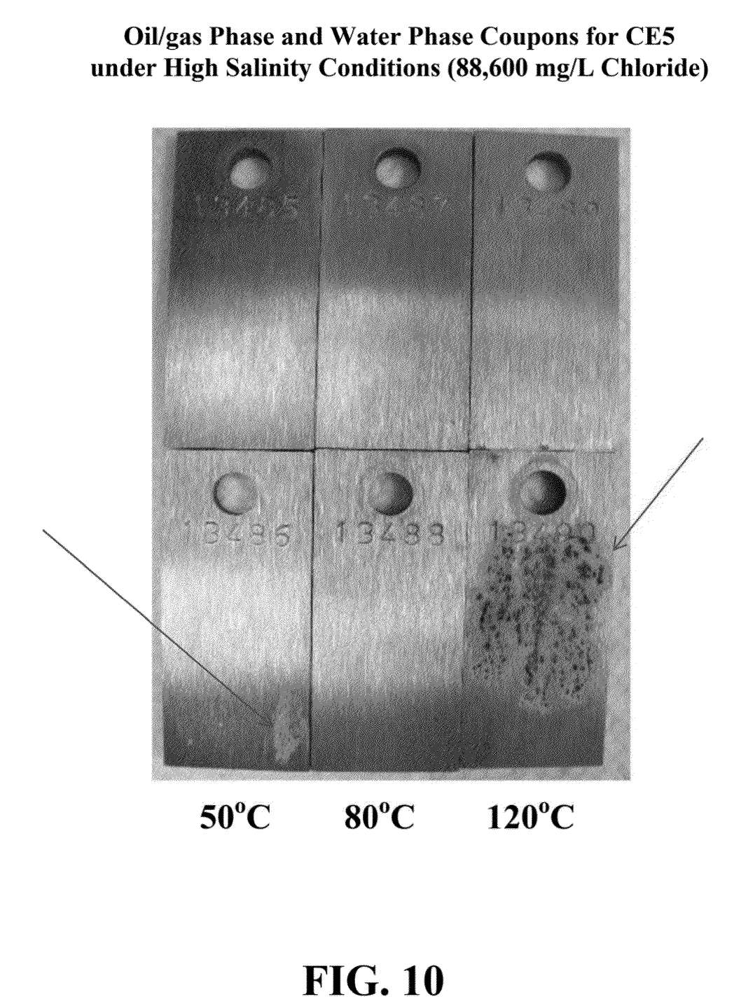

FIG. 10 depicts an oil/gas phase and water phase coupons from CE5 in a high salinity fluid (88,600 mg/L chloride).

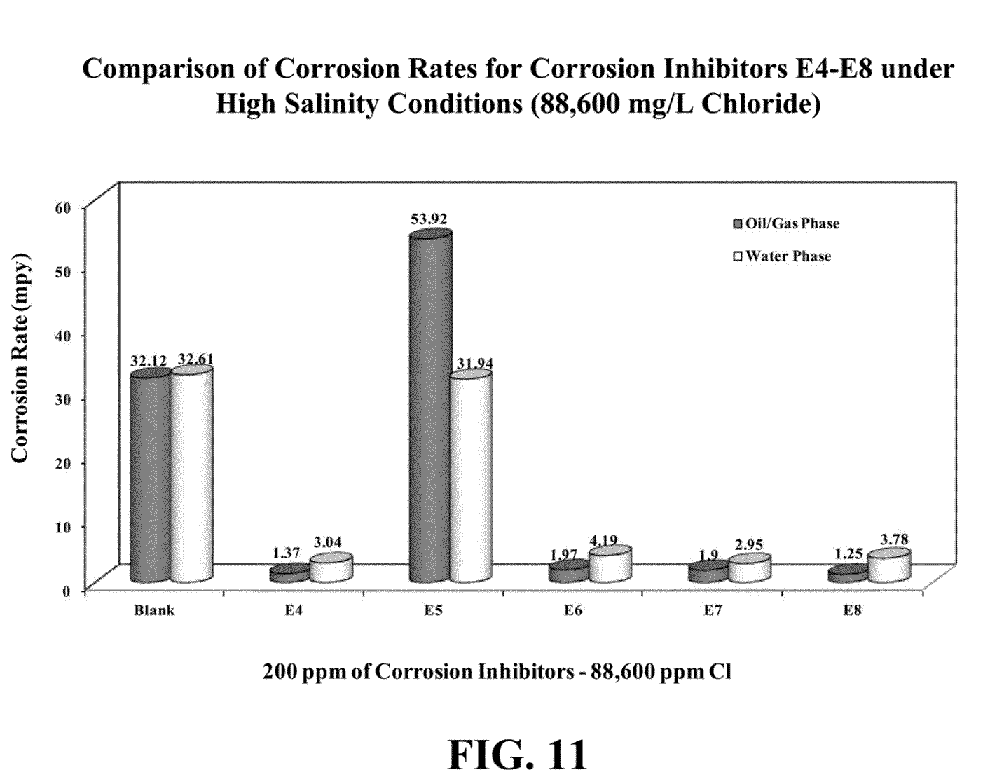

FIG. 11 depicts a comparison of non-alkyl pyridine corrosion inhibitors E4-E8 of this invention in a high salinity fluid (88,600 mg/L chloride).

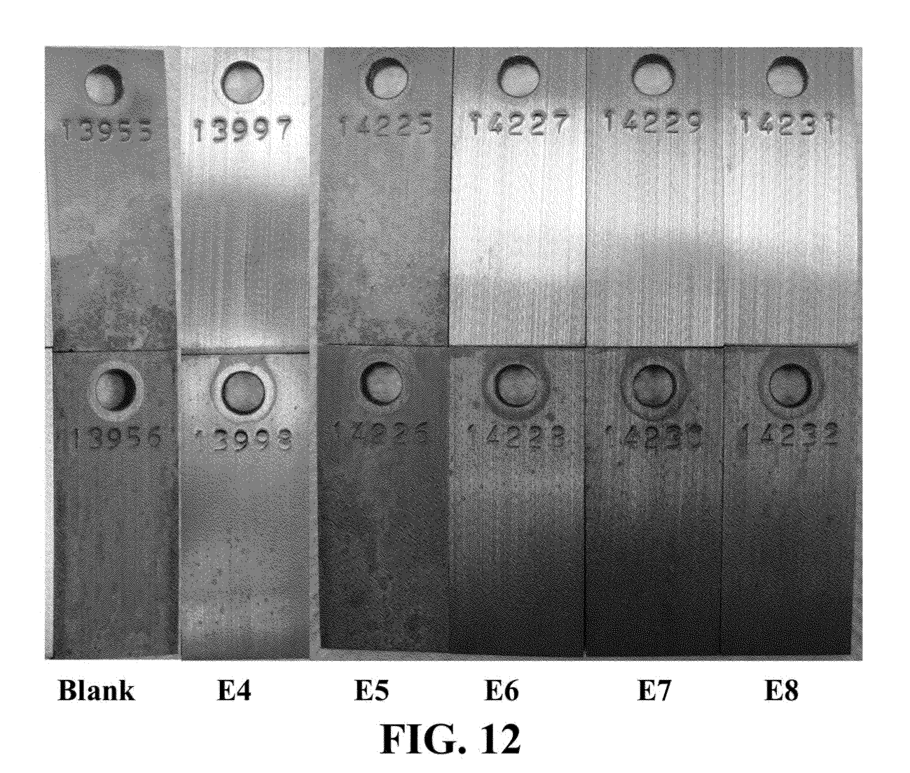

FIG. 12 depicts an oil/gas phase and water phase coupons for non-alkyl pyridine corrosion inhibitors E4-E8 of this invention in a high salinity fluid (88,600 mg/L chloride).

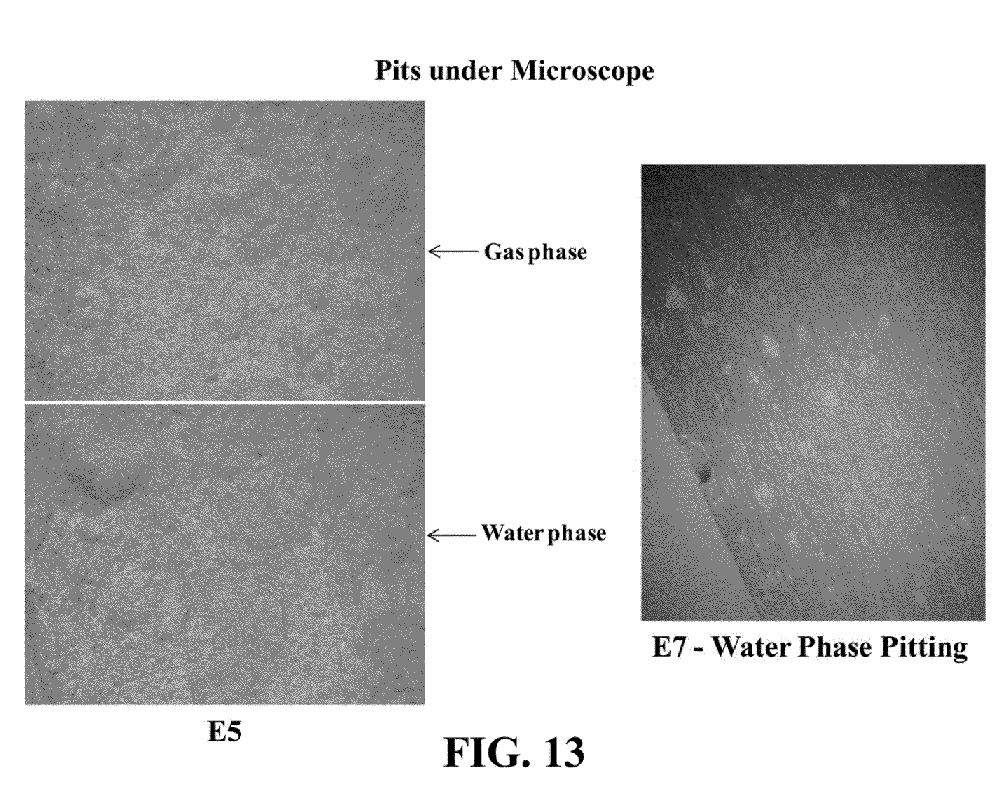

FIG. 13 depicts a comparison of coupons for non-alkyl pyridine corrosion inhibitors E5 and E7 (which has no trans-cinnamaldehyde).

### DETAILED DESCRIPTION OF THE INVENTION

The inventors have surprisingly found that low temperature hydrogen sulfide corrosion compositions may be formulated including a corrosion system including at least one dialkyl sulfate quaternary salt of 1,2-disubstituted imidazolines, 1,2-disubstituted imidazoline amides, bicyclic amines, amides of polyamines, and/or polyamines and an intensifier system. The inventors have found that the compositions provide consistent protection against corrosion at low temperatures between about 50° C. and about 120° C. (about 122° F. and about 248° F.) with no pitting and excellent protection in both an oil/gas phase and/or a water/aqueous phase. This is surprising because U.S. Pat. No. 5,697,443 teaches that intensifiers like formic acid and iodine are only effective in strong acids (e.g., 15% HCl) and high temperatures (e.g., >93° C. (200° F.)) and Gema Cabello et al. in Electrochimica Acta teaches formic acid and trans-cinnamaldehyde are effective only at high temperatures, high pressures, and in the presence of strong acids. On the other hand, H₂S is a weak acid. Dehydration of formic acid at 94° C. (201.2° F.) in the presence of a strong acid (e.g., HCl) generates CO, which is a good corrosion inhibitor. Trans-cinnamaldehyde requires high temperatures and pressures to polymerize and form a thin coating on the metal surface, but we have found that these intensifiers may be used with quaternary salts of dialkyl substituted imidazolines, dialkyl substituted imidazoline amides, amides of polyamines and/or polyamines for low temperature applications. While the present compositions find utility in hydrogen sulfide containing fluids, the compositions may also work equally well in fluid including other corrosive acids such as carbon dioxide, hydrogen cyanide, or other corrosive acids or hydrogen sulfide and other corrosive acids.

The inventors have also found that intensifiers including trans-cinnamaldehyde require high temperatures and high pressures in presence of a strong acid (e.g., HCl) to improve corrosion protection. When intensifiers including trans-cinnamaldehyde are blended with dialkyl sulfate quaternary salts of 1,2-disubstituted imidazolines, 1,2-disubstituted imidazoline amides, bicyclic amines, amides of polyamines, and/or polyamines, they improve the protection provided by the quaternary salts at low temperature between about 50° C. and about 120° C. (about 122° F. and about 248° F.) in a weak acid (e.g., H₂S). When intensifiers including trans-cinnamaldehyde are blended with alkyl pyridine quaternary salts, their corrosion protection becomes worse as compared to alkyl pyridine quaternary salts alone. When intensifiers including trans-cinnamaldehyde are blended with dialkyl sulfate quaternary salts of 1,2-disubstituted imidazolines, 1,2-disubstituted imidazoline amides, bicyclic amines, amides of polyamines, and/or polyamines, the resulting compositions provide the same protection across the temperature range between 50° C. and 120° C. (122° F. and 248° F.) without pitting and in both the oil/gas phase and water/aqueous phase.

The 1,2-disubstituted imidazolines and imidazoline amides, and/or amides of amines and/or polyamines are prepared by reacting at least one ethyleneamine, hydroxyl alkyl substituted ethyleneamine, and/or alkoxy alkyl substituted ethyleneamine with at least one mono carboxylic acid, a dimeric carboxylic acid, or a polymeric carboxylic acid.

The 1,2-disubstituted imidazolines, 1,2-disubstituted imidazoline amides, bicyclic amines, amides of polyamines, and/or polyamines are then reacted with a quaternizing agent. The quaternized versions thereof are then dissolved in a suitable solvent.

Quaternary salts of 1,2-disubstituted imidazolines, 1,2-disubstituted imidazoline amides, bicyclic amines, amides of polyamines, and/or polyamines have been found to be excellent anti-agglomerate gas hydrate inhibitors in sour conditions. Since they are also excellent corrosion inhibitors, the quaternized 1,2-disubstituted imidazolines, 1,2-disubstituted imidazoline amides, bicyclic amines, amides of polyamines, and/or polyamines provide both corrosion protection and gas hydrate inhibition.

The intensifier systems include low molecular weight carboxylic acids, iodide compounds, bismuth-containing compounds, antimony-containing compounds, nitrates, copper-containing compounds, or mixtures and combinations thereof.

### Compositional Ranges for Use in the Invention

The composition ranges of the reaction products of polyamines and carboxylic acids comprising 1,2-disubstituted imidazolines and 1,2-disubstituted imidazoline amides, and/or linear and/or branched amides of the polyamides. In general, the 1,2-disubstituted imidazolines and 1,2-disubstituted imidazoline amides comprise at least 51 wt. % of the reaction product with the reminder being amides of the polyamines. In certain embodiments, the reaction products comprise at least 60 wt. % of 1,2-disubstituted imidazolines and 1,2-disubstituted imidazoline amides with the reminder being amides of the polyamines. In certain embodiments, the reaction products comprise at least 70 wt. % of 1,2-disubstituted imidazolines and 1,2-disubstituted imidazoline amides with the reminder being amides of the polyamines. In certain embodiments, the reaction products comprise at least 80 wt. % of 1,2-disubstituted imidazolines and 1,2-disubstituted imidazoline amides with the reminder being amides of the polyamines. In certain embodiments, the reaction products comprise at least 90 wt. % of 1,2-disubstituted imidazolines and 1,2-disubstituted imidazoline amides with the reminder being amides of the polyamines.

Quaternary salts of the 1,2-disubstituted imidazolines and 1,2-disubstituted imidazoline amides, bicyclic amines, linear and/or branched amides of the polyamides, and/or polyamines of this invention include at least one nitrogen atom in the structure that includes four substituents and carries a positive charge counterbalanced by an alkyl sulfate anion. In certain embodiments, the quaternization reaction results in the complete or partial alkylation of NH groups found in the structure. Thus, if the structure include one or more tertiary amines and one or more primary and/or secondary amines (i.e., free NH groups), then the quaternization reaction will alkylate some or all of the NH groups in conjunction with converting the one or more tertiary amines into ammonium salts. In other embodiments, the quaternization reaction will result in the conversion to some or all primary, secondary, and/or tertiary amino groups into ammonium groups. For the purpose of this invention, only a single amino group in any given structure needs to be converted into an ammonium group. However, in certain embodiments, the resulting quaternized compositions may include compounds having more than one ammonium group per compound, which as one of ordinary skill in the art will depend on the compound being quaternized, the amount of quaternizing agent being used, and the reaction conditions under which the reaction is carried out.

### Suitable Reagants for Use in the Invention

Suitable 1,2-disubstituted imidazolines include, without limitation, compounds of the general Formula (I):

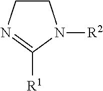

where R¹ is a saturated or unsaturated linear or branched alkyl group having 8 to 40 carbons, which may include a cyclic moiety, and R² is a hydroxyl (OH) terminated carbyl group having between 1 and 6 carbon atoms, an alkoxy (OR) terminated carbyl group having between 1 and 6 carbon atoms, or an amino (NR′R″) terminated carbyl group having between 1 and 6 carbon atoms, where R is a carbyl group having between 1 and 6 carbon atoms, R′ and R″ are a hydrogen atom or a carbyl group having between 1 and 6 carbon atoms. In certain embodiments, R² is —CH₂OH, —CH₂CH₂OH, —CH₂CH₂CH₂OH, —CH₂OCH₃, —CH₂CH₂OCH₃, —CH₂CH₂CH₂OCH₃, —CH₂NH₂, —CH₂CH₂NH₂, CH₂CH₂CH₂NH₂, CH₂NHCOR¹, CH₂CH₂NHCOR¹, CH₂CH₂CH₂NHCOR¹, CH₂OCOR¹, CH₂CH₂OCOR¹, CH₂CH₂CH₂OCOR¹, or mixtures and combinations thereof.

### Amines

Suitable amines include, without limitation, a) ethyleneamines, alkylated ethyleneamines, alkoxylated ethyleneamines, oligomers and polymers thereof; b) piperazines, alkylated piperazines, alkoxylated piperazines, oligomers and polymers thereof; c) polyheterocyclicamines, alkylated polyheterocyclicamines, alkoxylated polyheterocyclicamines, oligomers and polymers thereof; and d) mixtures or combinations thereof.

In certain embodiments, the amines include, without limitation, alkyleneamines, hydroxyl alkyl substituted alkyleneamines, and/or alkoxyalkyl substituted alkyleneamines, without limitation, compound of the following formulas:

ER^{a}(N(R³)R^{a})ₙ₁NR¹R² (II)

N(R^{b}E)(R^{c}E)((R^{d}N(R³))ₙ₂R^{d}NR¹R²) (III)

Z(R^{e}N(R³))ₙ₃R^{e}NR¹R² (IV)

ENR^{f}Z(R^{g}N(R³))ₙ₄R^{g}NR¹R² (V)

ENR^{f}(ZR^{f})nR^{g}NR¹R² (VI)

YR¹ (VII)

where each E group is independently a hydroxyl (OH) group, an alkoxy (OR) group, or an amino (NR′R″) group, W, R², and R³ are independently a hydrogen atom or a carbyl group having between 1 and 6 carbon atoms, each R^{a}, R^{b}, R^{c}, R^{d}, R^{e}, R^{f}, and R^{g} group is a carbyl linking group having between 1 and 6 carbon atoms, Z is a saturated hetero cyclic group including at least one nitrogen atom, Y is a saturated or unsaturated heterobicyclic group, R is a carbyl group having between 1 and 6 carbon atoms, R′ and R″ are a hydrogen atom or a carbyl group having between 1 and 6 carbon atoms, n₁ is an integer having a value between 2 and 10, n₂ is an integer having a value between 0 and 10, n₃ is an integer having a value between 0 and 10, and n₄ is an integer having a value between 1 and 10.

Exemplary the above identified amines include, without limitation, diethylenetriamine, 2-aminoethylethanolamine; triethylenetetramine, 4-(2-aminoethyl)diethylenetriamine, tetraethylenepentamine, 4-(2-aminoethyl)triethylenetetramine, pentaethylenehexamine (PEHA), hexaethyleneheptamine (HEHA), heptaethyleneoctamine (HEOA), octaethylenenonamine (OENA), higher molecular weight ethyleneamine, tetramethylethylenediamine, other alkylated ethyleneamines, oligomers, and polymers thereof, alkylated-1,4,7-triazabiclo[4.3.0]-non-6-ene, alkylated-1,4,7-triazabiclo[4.3.0]-non-4-ene, alkylated-1,4,7-triazabicylo[4.3.0]-non-4,6-diene, 5-methyl-1,4,7-triazabicylo[4.3.0]-non-4,6-diene,

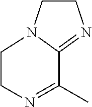

5-ethyl-1,4,7-triazabiclo[4.3.0]-non-6-ene,

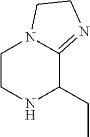

5-ethyl-1,4,7-triazabiclo[4.3.0]-non-4,6-diene,

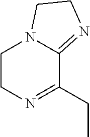

N-(2-aminoethyl)piperazine, N,N′-bis(2-aminoethyl)piperazine, 1,2-dipiperazinoethane, N(2-(1-piperazinyl)ethyl)ethylenediamine, N(2-piperazinoethyl)diethylenetriamine, N(2-(2-aminoethyl)ethyl)-N′-(2-aminoethyl)piperazine, bis(2-piperazinoethyl)amine, N(2-piperazinoethyl)-N′-(2-aminoethyl)piperazine, and piperazine oligomers, 1,4-dimethylpiperazine, their piperazine constituents thereof, mixtures of ethyleneamines, crude ethyleneamines, crude aminoethylethanolamine, N-hydroxyethyldiethylenetriamine, 1,7-bis(hydroxyethyl)diethylenetriamine, tris(hydroxyethyl)diethylenetriamine, tetra(hydroxyethyl)diethylenetriamine, hydroxethyltriethylentetramine, N,N′-bis(hydroxyethyl)triethylenetetramine, tris(hydroxyethyl)triethylenetetramine, tetra(hydroxyethyl)triethylenetetramine, penta(hydroxyethyl)triethylenetetramine, N-(hydroxyethyl)tetraethylenepentamine, N,N′-bis(hydroxyethyl)tetraethylenepentamine, tetra(hydroxyethyl)tetraethylenepentamine, penta(hydroxyethyl)tetraethylenepentamine, hexa(hydroxyethyl)tetraethylenepentamine, ethoxylated pentaethylenehexamine, ethoxylated hexaethyleneheptamine, ethoxylated heptaethyleneoctamine, ethoxylated ethyleneamines, other ethoxylated ethyleneamines, ethoxylated amines and their mixtures.

Suitable ethyleneamines products include Molex ethyleneamines such as Molex A-1328, Molex A-1320, Molex A-1303, Molex 1783L, and the corresponding alkylated ethyleneamines and hydroxylated ethyleneamines and mixtures or combinations thereof. Molex A-1328 is a mixture of N-(2-aminoethyl)piperazine, 2-aminoethylethanolamine, N-(2-hydroxyethyl)piperazine, 5-ethyl-1,4,7-triazabicylco[4.3.0]-non-6-ene, 5-ethyl-1,4,7-triazabicylo[4.3.0]non-4,6-diene, and 1-[(2-1-aminoethypamino]-1-hydroxyethyl. Suitable ethoxylated ethyleneamines include E-100.

Exemplary examples of compounds of the above formulas include, without limitation, ethyleneamines, hydroxylalkyl substituted ethyleneamines, and/or alkoxyalkyl substituted ethyleneamines. Ethyleneamines are linear, branched, and some contain piperazine rings. Exemplary examples include, without limitation, N-aminoethylethanolamine, diethylenetriamine, crude aminoethylethanolamine, N-(2-hydroxyethyl)piperazine, hydroxyethyl diethylenetriamine (or 2-[[2-[(2-aminoethyl)amino]ethyl]amino]-ethanol), triethylentetramine, tetraethylenepentamine, or mixtures or combinations thereof.

In certain embodiments, the amines used to prepare the corrosion inhibitors of this invention include, without limitation, ethyleneamines, hydroxylalkyl substituted ethyleneamines, and/or alkoxyalkyl substituted ethyleneamines, alkylated, hydroxyalkylated, alkylated, hydroxyalkylated, and/or alkoxyalkylated imidazolines, alkylated, hydroxyalkylated, and/or alkoxyalkylated piperizines, or mixtures structures of illustrative and non-limiting examples of amines of this invention given by the general Formulas (VIII-XXX) are shown in FIGS. 1A-E, where i is an integer having a value between 2 and 20, j is an integer having a value between 1 and 20, and k is an integer having a value between 0 and 20. In certain embodiments, i is an integer having a value between 2 and 16, j is an integer having a value between 1 and 16, and k is an integer having a value between 0 and 16. In certain embodiments, i is an integer having a value between 2 and 12, j is an integer having a value between 1 and 12, and k is an integer having a value between 0 and 12. In certain embodiments, i is an integer having a value between 2 and 10, j is an integer having a value between 1 and 10, and k is an integer having a value between 0 and 10. In certain embodiments, i is an integer having a value between 2 and 8, j is an integer having a value between 1 and 8, and k is an integer having a value between 0 and 8.

Referring now to FIG. 1E, the general structures of certain bicyclic amines Formulas (XXIX and XXX) are shown that are present in the starting materials used in the reaction with fatty acids to form the materials of Formula (I), but do react with the quaternizing agents to form the quaternary compositions of this invention.

### Carboxylic Acids

Suitable mono carboxylic acids include, without limitation, saturated and/or unsaturated linear or branched fatty acids having between 12 and 40 carbon atoms. Exemplary fatty acids include, without limitation, oleic acid, linoleic acid, coco fatty acid, or mixtures and combinations thereof.

### Dicarboxylic Acids

Suitable dicarboxylic acids include, without limitation, saturated and/or unsaturated dicarboxylic acids having between 12 and 80 carbon atoms. Exemplary examples include, without limitation, dimers of tallow oleic acid to form dibasic acids containing, on average, a 36 carbon molecule with two carboxylic acid groups such as Emery 1003 dimer acids.

### Polycarboxylic Acids

Suitable polycarboxylic acids include, without limitation, polycarboxylic acids including more than two carboxylic acid groups and having between 12 and 10,000 carbon atoms. Exemplary examples include, without limitation, polymers of tallow oleic acid to form a polybasic acids containing, on average, a 72 carbon molecule with more than two carboxylic acid groups.

### Quaternizing Agents

Suitable quaternizing agents include, without limitation, compounds of the general formula:

R⁰A¹

or

(R⁰)₂A²

where each R⁰ is independently a linear, branched or cyclic alkyl group, an aryl group, alkylated aryl group, an arylated alkyl group (where the alkyl groups are linear, branched and/or cyclic), or mixtures and combinations thereof and A¹ is a halogen atom (e.g., F, Cl, Br, and/or I) and A² is a sulfate group, ethyletheryl, or mixtures or combinations thereof, additionally A¹ and A² may be exchanged with group such as hydroxide ions or acetate ions. In certain embodiments, the quaternary agents are dimethyl sulfate, diethyl sulfate, or mixtures and combinations.

### Solvents

Suitable solvents include, without limitation, methanol, ethanol, isopropanol, ethylene glycol, other similar compounds or mixtures and combinations.

### Intensifiers

Suitable intensifiers include, without limitation, low molecular weight carboxylic acids, unsaturated aldehydes, iodide compounds, bismuth-containing compounds, antimony-containing compounds, nitrates, copper-containing compounds, or mixtures and combinations thereof.

Suitable low molecular weight carboxylic acids include carboxylic acids having from about 1 to 5 carbon atom. Exemplary low molecular weight carboxylic acids include, without limitation, formic acid, acetic acid, propanoic acid, oxalic acid, maleic acid, chloroacetic acid, dichloroacetic acid, trichloroacetic acid, trifluoroacetic acid, or mixtures and combinations thereof.

Suitable iodide compounds include, without limitation, lithium iodide, sodium iodide, potassium iodide, cesium iodide, ammonium iodide, tetrabutylammonium iodide, copper iodide, or mixtures and combinations thereof.

Suitable bismuth compounds include, without limitation, bismuth trichloride, bismuth triiodide, bismuth triflouride, alkali metal salts of bismuth tartrate, bismuth adducts of ethylene glycol, bismuth trioxide, other trivalent bismuth compounds, BiCl₃, BiOCl, Bi₂O₃, other bismuth oxides, or mixtures and combinations thereof.

Suitable antimony-containing compounds include, without limitation, antimony trioxide, antimony pentaoxide, antimony trichloride, antimony pentachloride, antimony trifluoride, antimony sulfide, antimony tartrate, potassium pyroantimonate, alkali metal salts of antimony tartrate such as potassium antimony tartrate, antimony adducts of ethylene glycol, other trivalent or pentavalent antimony compounds, or mixtures and combinations thereof.

Suitable copper-containing compound include, without limitation, cuprous chloride, cuprous iodide, cupric chloride, cupric iodide, or mixtures and combination thereof.

Additionally, metal compounds selected from the group consisting of antimony compounds, bismuth compounds, and copper compound may be mixed with a secondary metal ion selected from the group consisting of Ca, Al, Mg, Zn, Zr, or mixtures thereof to form mixed metal ion intensifiers.

Suitable nitrates include, without limitation, lithium nitrate, sodium nitrate, potassium nitrate, cesium nitrate, or mixtures and combinations thereof.

Suitable unsaturated aldehydes include, without limitation, cinnamaldehyde, trans-cinnamaldehyde, α,β unsaturated aldehydes given by the following general formula:

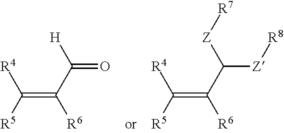

wherein: R⁴ represents: a saturated or unsaturated aliphatic hydrocarbon group containing from about 3 to about 12 carbon atoms; a substituted saturated or unsaturated aliphatic hydrocarbon group containing from about 3 to about 12 carbon atoms and containing one or more non-interfering substituents; an aryl group, e.g., phenyl, benzyl or the like; a substituted aryl group containing one or more non-interfering substituents; or, a non-interfering substituent per se. R⁵ represents: hydrogen; a saturated or unsaturated aliphatic hydrocarbon group containing from 1 to about 5 carbon atoms; a substituted saturated aliphatic hydrocarbon group containing from 1 to about 5 carbon atoms and containing one or more noninterfering substituents; an aryl group; a substituted aryl group containing one or more non-interfering substituents; or, a no-interfering substituent per se. R⁶ represents: hydrogen; a saturated or unsaturated aliphatic hydrocarbon group containing from about 3 to about 12 carbons atoms; a substituted saturated or unsaturated aliphatic hydrocarbon group containing from about 3 to about 12 carbon atoms and containing one or more non-interfering substituents; an aryl group; a substituted aryl group containing one or more non-interfering substituents; or, a non-interfering substituent per se. The total number of carbon atoms in substituents represented by R⁴, R⁵, and R⁶ range from 1 to 16. In certain embodiments, the total number of carbon atoms in substituents represented by R⁴, R⁵, and R⁶ range from 5 to 10. The “non-interfering substituents” referred to above are those substituents that have no adverse effect on the corrosion inhibition. They include, for example, lower alkyl (containing from 1 to about 4 carbon atoms), lower alkoxy (containing from 1 to about 4 carbon atoms), halo (e.g., fluoro, chloro, bromo or iodo), hydroxyl, dialkylamino, cyano, thiocyano, N,N-dialkylcarbamoylthio and nitro substitutents. Z and Z′ represents an oxygen or sulfur atom; R⁷ and R⁸ may be a substituted saturated or unsaturated aliphatic hydrocarbon group hydroxyl or carboxylic acid groups or can be linked with each other through an aliphatic group having 2-6 carbon atoms.

Examples of other cinnamaldehyde derivatives include, without limitation, dicinnamaldehyde, p-hydroxycinnamaldehyde, p-methylcinnamaldehyde, p-ethylcinnamaldehyde, p-methyloxycinnamaldehyde, p-dimethylaminocinnamaldehyde, p-diethylaminocinnamaldehyde, p-nitrocinnamaldehyde, o-nitrocinnamaldehyde, o-allyloxycinnamaldehyde, 4-(3-propenal)cinnamaldehyde, p-sodium sulfocinnamaldehyde, p-trimethylammoniumcinnamaldehyde sulfate, p-trimethylammoniumcinnamaldehyde, p-thiocyanocinnamaldehyde, p-(S-acetyl)thiocinnamaldehyde, p-(S—N,N-dimethylcarbamoylthio)cinnamaldehyde, p-chlorocinnamaldehyde, alpha-methylcinnamaldehyde, beta-methylcinnamaldehyde, alpha-chloro cinnamaldehyde, alpha-bromocinnamaldehyde, alpha-butylcinnamaldehyde, alpha-amylcinnamaldehyde, alpha-hexylcinnamaldehyde, alpha-bromo-p-cyanocinnamaldehyde, alpha-ethyl-p-methylcinnamaldehyde, p-methyl-alpha-pentylcinnamaldehyde, cinnamaloxime, cinnamonitrile, or mixtures and combinations thereof.

Thioacetals of cinnamaldehyde and crotoanaldehyde include, without limitation, diethioethanol acetal of cinnamaldehyde,

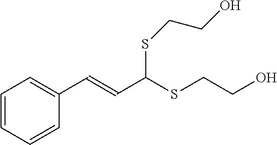 [SMILES: OCCSC(/C=C/c1ccccc1)SCCO]

1,2-dithiolane of cinnamaldehyde,

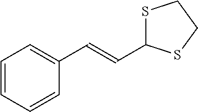 [SMILES: C(=C\C1SCCS1)/c1ccccc1]

1,2-dithioacetic acid acetal of cinnamaldehyde,

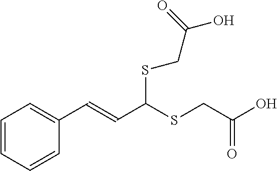 [SMILES: O=C(O)CSC(/C=C/c1ccccc1)SCC(=O)O]

dithioethanol acetal of crotonaldehyde,

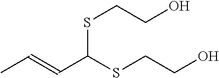

1,2-oxathiolane of crotonaldehyde,

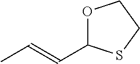

For further details on these materials the reader is directed to Unite States Published Application No. 2005/0169794.

Cinnamaldehyde type molecules may be prepared by reacting benzyl aldehyde with various acetaldehyde. These molecules are represented by the following general formula:

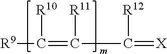

wherein R⁹ is phenyl or a phenyl group substituted with one or more of the groups methyl, hydroxyl, methoxy or other substituent which does not have an adverse effect; R¹⁰ and R¹¹ are individually hydrogen, a saturated or unsaturated aliphatic group having from 1 to about 12 carbon atoms, an aryl group or other substituent which does not have an adverse effect; R¹² is hydrogen, —(NH—CH₂—CH₂)ₘ—NH—CH₂CH₂NH₂, where m is 0 or an integer in the range of from 1 to 5, a tris(2-aminoethyl)amine group or other substituent which does not have an adverse effect; n is an integer in the range of from 2 to 7, and X is oxygen, NH or other N-substituent which does not have an adverse effect. For further details the reader is directed to U.S. Pat. No. 6,180,057.

### EXPERIMENTS OF THE INVENTION

The inventors have found that corrosion inhibitors of this invention are prepared by reacting ethyleneamines and/or hydroxyl alkyl substituted ethyleneamines with mono, di or poly carboxylic acids to form 1,2-disubstituted imidazolines, 1,2-disubstituted imidazolines amides, amide of polyamines, and/or polyamines. Some of these amine products also include bicyclic amines, which do not or minimally participate in the reaction with the carboxylic acids. The inventor have also found that the 1,2-disubstituted imidazolines, bicyclic amines, amide of polyamines, and/or polyamines may then be reacted with a quaternization agent to form quaternary salts of 1,2-disubstituted imidazolines, 1,2-disubstituted imidazolines amides, bicyclic amines, amide of amines and/or polyamines. The quaternary salts of 1,2-disubstituted imidazolines, 1,2-disubstituted imidazolines amides, bicyclic amines, amide of polyamines, and/or polyamines are then dissolved in a suitable solvent. The quaternized 1,2-disubstituted imidazolines, 1,2-disubstituted imidazolines amides, bicyclic amines, amide of polyamines, and/or polyamines have been found to be excellent anti-agglomerate gas hydrate inhibitors in sour conditions. Since they are also excellent corrosion inhibitors, the quaternized dialkyl imidazoline, bicyclic amines, amide of polyamines, and/or polyamines providing both corrosion protection and gas hydrate inhibition.

The 1,2-disubstituted imidazolines are represented by Formula (I):

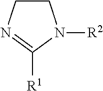

where R¹ and R² are as previously defined.

Illustrative and non-limiting examples of reaction of amines of this invention with oleic acid are shown in FIGS. 2A-C, while illustrative and non-limiting examples of quaternary salts of compounds of Formulas (I-XXXI) are shown in FIGS. 3A-C.

### Example 1

18200 pounds tall oil fatty acid were added to a reactor equipped with temperature control, nitrogen blanket and purge capability, vacuum pump and trap. Tall oil fatty acid is generally a mixture of palmitic acid, oleic acid, and linoleic acid. 6500 pounds N-(2-aminoethyl)ethanolamine (AEEA) were added to the reactor. The contents were heated to 162.8° C. (325° F.) with a nitrogen blanket until a Total Amine Value (TAV) of 140 to 155 was achieved. 520 pounds of N-(2-aminoethyl)ethanolamine was added to reach the 140 to 155 TAV. The cook was continued at 162.8° C. (325° F.) until acid number was below 10. After the acid number was below 10, another 520 pounds of the AEEA was added to achieve a TAV of 173 to 183. The nitrogen blanket was turned off and nitrogen purge was turned on. The contents were heated to 190.6° C. (375° F.).

The TAV was checked until TAV was above 163. With FTIR, the imide/amide ratio was checked. The reactor contents were continued to cook at 190.6° C. (375° F.) with a purge as long as TAV was coming down and I/A was going up. Vacuum pump was tuned on. A vacuum above 20 inches was achieved with purge still on. The contents were cooled under vacuum with purge. Final TAV was between 160 and 173. Final I/A was between 3.0:1.0 to 10.00:1.0.

480 g of reaction product of N-(2-aminoethyl)ethanolamine and tall oil fatty acid were added to a 1 L resin kettle equipped with a thermocouple, thermocouple well, dean-stark trap, Vigreux distillation column and Friedrichs column on top. The contents were heated to 65.6° C. (150° F.). 152 g of diethyl sulfate were added to reactor contents at 65.6° C. (150° F.). The temperature rose to 79.4° C. (175° F.). Diethyl sulfate addition was re-started after the temperature stopped rising. The temperature was maintained between 79.4° C. (175° F.) and 93.3° C. (200° F.) during most of the diethyl sulfate addition. When the reaction was complete, Total Amine Value (TAV) of the reaction product was below 30 and pH was between 7 and 9. The remaining 8 g of diethyl sulfate was used to lower both the TAV and pH. If the pH was below 7.5, no additional diethyl sulfate was added. The contents were cooled down to 65.6° C. (150° F.) and 160 g methanol added and the solids content was 80%. This product is sometimes designated at E1.

### Example 2

700.5 g of tall oil fatty acid were added to a reactor equipped with temperature control, nitrogen blanket and purge capability, vacuum pump and trap. 250.5 g A-1328 were added to the reactor. A-1328 is a blend of 65 wt. % N-(2-aminoethyl)ethanolamine, 23 wt. % N-(2-aminoethyl)piperazine, 1.4 wt. % 5-ethyl-1,4,7-triazabicyclo(4.3.0)non-4,6-diene, 0.8 wt. % 5-ethyl-1,4,7-triazabicyclo(4.3.0)non-6-ene and 10.2% triethylenetetramine. The contents were heated to 162.8° C. (325° F.) with a nitrogen blanket until a Total Amine Value (TAV) of 140 to 155 was achieved. 20 grams of A-1328 was added to reach the 140 to 155 TAV. The cook was continued at 162.8° C. (325° F.) until the acid number was below 10. After the acid number was below 10, another 20 pounds of the A-1328 was added to achieve a TAV of 175 to 185. The nitrogen blanket was turned off and nitrogen purge was turned on. The contents were heated to 190.6° C. (375° F.). The TAV was checked every hour until the TAV was above 175. With FTIR, the imide/amide (I/A) ratio was checked. The reactor contents continued to cook at 190.6° C. (375° F.) with a purge as long as TAV was decreasing and the I/A ratio was increasing. Vacuum pump was turned on. A vacuum above 20 inches was achieved with purge still on. The contents were cooled under vacuum with purge. The final TAV was between 175 and 185. The final I/A ratio was between 1.5 to 2.5.

580 grams of the reaction product of A-1328 and tall oil fatty acid were added to a 2-liter resin kettle equipped with a thermocouple, thermocouple well, Vigreux distillation column and Friedrichs column on top. The contents were heated to 65.6° C. (150° F.). 220 grams of diethyl sulfate were added drop wise to reactor contents at 65.6° C. (150° F.). The temperature rose to 79.4° C. (175° F.). Diethyl sulfate addition were re-started after the temperature stopped rising. The temperature was maintained between 79.4° C. and 93.3° C. (175° F. and 200° F.) during most of the diethyl sulfate addition. When the reaction was complete, the TAV was measured to be 23 and the pH was measured to be 6.5. The contents were cooled to 65.6° C. (150° F.) and 200 grams of methanol were added. The solids content was measured to be 80 wt. %. This product is sometimes designated at E2.

### Example 3

The present example illustrate the formulation of an intensified corrosion inhibitor including E1 and an intensifier composition including ammonium iodide, water, trans-cinnamaldehyde, and formic acid.

2.81 grams of ammonium iodide were dissolved in 5.08 grams water to form an aqueous solution of ammonium iodide. 68.07 g of E1 was formulated with an intensifier system including the aqueous solution of ammonium iodide, 39.30 g trans-cinnamaldehyde, and 91.67 g formic acid. This product is sometimes designated at E3.

### Example 4

The present example illustrate the formulation of an intensified corrosion inhibitor including E2 and an intensifier composition including ammonium iodide, water, trans-cinnamaldehyde, and formic acid.

32.9 g of E2 was formulated with an intensifier system including 1.36 g ammonium iodide, 2.45 g water, 18.99 g trans-cinnamaldehyde, and 44.3 g formic acid. This product is sometimes designated at E4.

### Example 5

The present example illustrate the formulation of an intensified corrosion inhibitor including only an intensifier composition including ammonium iodide, water, trans-cinnamaldehyde, and formic acid and a solvent system including isopropanol.

1.36 g of ammonium iodide, 2.45 g of DI water, 18.99 g of trans-cinnamaldehyde, 44.3 g of formic acid, and 32.9 g of isopropanol were mixed. This product is sometimes designated at E5.

### Example 6

The present example illustrate the formulation of an intensified corrosion inhibitor including E2 and an intensifier composition including water, trans-cinnamaldehyde, and formic acid and a solvent system including isopropanol.

32.9 g of E2 was formulated with 2.45 g of DI water, 18.99 g of trans-cinnamaldehyde, 44.3 g of formic acid, and 1.36 g of isopropanol were mixed. This product is sometimes designated at E6.

### Example 7

The present example illustrate the formulation of an intensified corrosion inhibitor including E2 and an intensifier composition including ammonium iodide, water, and formic acid and a solvent system including isopropanol.

32.9 g of E2 was formulated with 1.36 g of ammonium iodide, 2.45 g of DI water, 44.3 g of formic acid, and 18.99 g of isopropanol were mixed. This product is sometimes designated at E7.

### Example 8

The present example illustrate the formulation of an intensified corrosion inhibitor including E2 and an intensifier composition including ammonium iodide, water, and trans-cinnamaldehyde, and a solvent system including isopropanol.

32.9 g of E2 was formulated with 1.36 g of ammonium iodide, 2.45 g of DI water, 18.99 g of trans-cinnamaldehyde, and 44.3 g of isopropanol were mixed. This product is sometimes designated at E8.

TABLE 1
Component Make Up of E4-E8

| Component | E4 | E5 | E6 | E7 | E8 |
|---|---|---|---|---|---|
| H₄NI | 1.36 | 1.36 | — | 1.36 | 1.36 |
| DI water | 2.45 | 2.45 | 2.45 | 2.45 | 2.45 |
| E2 | 32.90 | — | 32.90 | 32.90 | 32.90 |
| t-CA | 18.99 | 18.99 | 18.99 | — | 18.99 |
| FA | 44.30 | 44.30 | 44.30 | 44.30 | — |
| IPA | — | 32.90 | 1.36 | 18.99 | 44.30 |

t-CA = trans-cinnamaldehyde;
FA = formic acid;
IPA = isopropanol

### Comparative Example 1

7500 pounds Akolidine 10 were added to a reactor equipped with temperature control. 1500 pounds of methanol and 150 pounds of monoethanolamine were added and agitation started. The vent to carbon tower was closed. The reaction mixture was heated to 42.2° C. (108° F.) and then steam was turned off. The mixture was maintained for 20 minutes and then the jacket was filled with water. The reactor temperature dropped to a temperature between 65.6° C. and 73.9° C. (150° F. and 165° F.). The water lines were closed when jacket was full. 3698 pounds benzyl chloride were added at a rate of 25 pounds per minute. Benzyl chloride addition was continued, while maintaining the temperature at a maximum of 110° C. (230° F.) until all 3698 pounds of benzyl chloride had been added. The reaction product was then held at temperature for 30 minutes, while keeping the temperature above 101.7° C. (215° F.). The pH was above 4.5 and the Total Amine Value (TAV) above 20. The reaction product was maintained at temperature for 30 minutes and the pH and the TAV were rechecked. Since the TAV was not dropping, an additional 652 pounds of benzyl chloride were added and the reaction product was maintained at temperature for an additional 30 minutes. The TAV was measured to be less than 20. The reaction product was cooled to 57.2° C. (135° F.) and 1500 pounds of methanol were added and mixed for 30 minutes. The final pH of the reaction product was between 4.0 and 5.0 and had a solids content of 80 wt. %. This product is designated at CE1.

### Comparative Example 2

3784 pounds PAP-220 and 3784 pound Akolidine 10 were added to a reactor equipped with temperature control. 2056 pounds of methanol was added and agitation was started. The carbon tower vent was then closed. 4054.5 pounds of benzyl chloride were added, heated to 48.9° C. (120° F.) and then the steam was turned off. The temperature was in the range between 79.4° C. and 107.2° C. (175° F. and 225° F.), when 4045.5 pounds benzyl chloride were added. Waited 30 minutes after no further increase in temperature. After 30 minutes, checked pH. pH was between 4.0 and 5.5 and TAV was between 10 and 20. 715.5 pounds of benzyl chloride were added. The reaction product was maintained at temperature until the TAV was less than 20 and initial pH was between 4.0 and 5.5. The reaction mixture was cooled to a temperature below 65.6° C. (150° F.). 2056 pounds of methanol were added and mixed for 30 minutes. The final pH of the reaction product was between 4.0 and 5.5, the final TAV was between 10 and 20 and the solids content was 75 wt. %. This product is designated at CE2.

### Comparative Example 3

21.35 grams of CE1 and 11.55 grams of CE2 were blended with 1.36 grams ammonium iodide, 2.45 grams water, 18.99 grams trans-cinnamaldehyde, and 44.3 grams formic acid. This product is designated at CE3.

### Comparative Example 4

21.35 g of CE1 and 11.55 g of CE2 were blended with 1.36 g ammonium iodide, 2.45 g water, 18.99 g trans-cinnamaldehyde, 42.3 g formic acid, and 2 g C₁₂-C₁₅ ethoxylated alcohol (17 moles) (LA-230). This product is designated at CE4.

TABLE 2
Component Make Up of E4, CE3, and CE4

| Component | E4 | CE3 | CE4 |
|---|---|---|---|
| HN₄I | 1.36 | 1.36 | 1.36 |
| DI water | 2.45 | 2.45 | 2.45 |
| E2 | 32.9 | — | — |
| CE1 | — | 21.35 | 21.35 |
| CE2 | — | 11.55 | 11.55 |
| t-CA | 18.99 | 18.99 | 18.99 |
| FA | 44.3 | 44.3 | 42.3 |
| LA-230 | — | — | 2.0 |

t-CA = trans-cinnamaldehyde;
FA = formic acid;
IPA = isopropanol;
C₁₂-C₁₅ ethoxylated (17 mole) alcohol

### Comparative Example 5

18.5 g of CE1 and 10 g of CE2 were blended with 20 g water, 30 g isopropanol, 10 g methanol, 2 g C₁₂-C₁₅ ethoxylated (17 mole) alcohol, 2 g FEP 530, 2 g diethylamine, 2.5 g Quatrex 182, and 3 g EC9541A. This product is sometimes designated at CE5.

### Example 9

1018 carbon steel coupons were tested using 200 ppm of different compositions. The tests were performed in a bench top autoclave from Parr Instrument Company. The test conditions consisted of 35% H₂S, 4% CO₂, and 88,600 mg/L Chloride at a temperature of 50° C. (122° F.).

### RESULTS AND DISCUSSIONS

The testing of the corrosion inhibitors of this invention versus the comparative inhibitors are tabulated in Tables 3-6 below.

TABLE 3
Corrosion Data for E4 vs. CE3 and CE4 in Low Chloride (10,000 ppm) Environments

| | Conc. | Speed | T | CO₂ | H₂S | P | Corrosion Rate | | |
|---|---|---|---|---|---|---|---|---|---|
| Product | (ppm) | RPM | (° C.) | (%) | (%) | (psi) | (mpy) | Phase | Observation |
| Blank | 0 | 30 | 30 | 14 | 123 | 350 | 5.60 | Oil/gas | no pits |
| | | | | | | | 9.74 | water | no pits |
| E4 | 100 | 30 | 30 | 14 | 123 | 350 | 1.14 | Oil/gas | no pits |
| | | | | | | | 0.60 | water | no pits |
| CE3 | 100 | 30 | 30 | 14 | 123 | 350 | 4.30 | Oil/gas | no pits |
| | | | | | | | 2.52 | water | pits |
| CE4 | 100 | 30 | 30 | 14 | 123 | 350 | 3.55 | Oil/gas | no pits |
| | | | | | | | 0.54 | water | no pits |

TABLE 4
Corrosion Data for E4 vs. CE5 in Low Chloride (10,000 ppm) Environments

| | Conc. | Speed | T | CO₂ | H₂S | P | Corrosion Rate | | |
|---|---|---|---|---|---|---|---|---|---|
| Product | (ppm) | RPM | (° C.) | (%) | (%) | (psi) | (mpy) | Phase | Observation |
| CE5 | 200 | 30 | 50 | 14 | 123 | 350 | 1.86 | Oil/gas | no pits |
| | | | | | | | 2.87 | water | pits |
| E4 | 200 | 30 | 50 | 14 | 123 | 350 | 1.29 | Oil/gas | no pits |
| | | | | | | | 0.30 | water | no pits |
| CE5 | 200 | 30 | 80 | 14 | 123 | 350 | 1.10 | Oil/gas | no pits |
| | | | | | | | 1.54 | water | pits |
| E4 | 200 | 30 | 80 | 14 | 123 | 350 | 0.86 | Oil/gas | no pits |
| | | | | | | | 1.79 | water | no pits |
| CE5 | 200 | 30 | 120 | 14 | 123 | 350 | 1.97 | Oil/gas | no pits |
| | | | | | | | 3.85 | water | pits |
| E4 | 200 | 30 | 120 | 14 | 123 | 350 | 1.48 | Oil/gas | no pits |
| | | | | | | | 2.5 | water | no pits |

TABLE 5
Corrosion Data for E4 vs. CE3 and CE4 in High Chloride (88,600 ppm) Environments

| | Conc. | Speed | T | CO₂ | H₂S | P | Corrosion Rate | | |
|---|---|---|---|---|---|---|---|---|---|
| Product | (ppm) | RPM | (° C.) | (%) | (%) | (psi) | (mpy) | Phase | Observation |
| CE3 | 200 | 30 | 50 | 14 | 123 | 350 | 8.24 | oil/gas | pits |
| | | | | | | | 1.34 | water | pits |
| CE4 | 200 | 30 | 50 | 14 | 123 | 350 | 4.75 | oil/gas | pits |
| | | | | | | | 1.68 | water | pits |
| CE3 | 200 | 30 | 80 | 14 | 123 | 350 | 2.17 | oil/gas | no pits |
| | | | | | | | 22.83 | water | pits |
| CE4 | 200 | 30 | 80 | 14 | 123 | 350 | 1.66 | oil/gas | no pits |
| | | | | | | | 16.90 | water | pits |
| CE3 | 200 | 30 | 120 | 14 | 123 | 350 | 13.52 | oil/gas | pits |
| | | | | | | | 37.40 | water | pits |
| CE4 | 200 | 30 | 120 | 14 | 123 | 350 | 4.81 | oil/gas | pits |
| | | | | | | | 38.43 | water | pits |

TABLE 6
Corrosion Data in High Chloride (88,600 ppm) Environments

| | Conc. | Speed | T | CO₂ | H₂S | P | Corrosion Rate | | |
|---|---|---|---|---|---|---|---|---|---|
| Product | (ppm) | RPM | (° C.) | (%) | (%) | (psi) | (mpy) | Phase | Observation |
| Blank | 200 | 30 | 50 | 4 | 35 | 350 | 4.84 | oil/gas | no pits |
| | | | | | | | 13.25 | water | no pits |
| CE5 | 200 | 30 | 50 | 4 | 35 | 350 | 0.43 | oil/gas | no pits |
| | | | | | | | 7.72 | water | pits |
| E4 | 200 | 30 | 50 | 4 | 35 | 350 | 0.94 | oil/gas | no pits |
| | | | | | | | 0.25 | water | no pits |
| Blank | 200 | 30 | 80 | 4 | 35 | 350 | 20.84 | oil/gas | no pits |
| | | | | | | | 19 | water | no pits |
| CE5 | 200 | 30 | 80 | 4 | 35 | 350 | 0.54 | oil/gas | no pits |
| | | | | | | | 0.6 | water | no pits |
| E4 | 200 | 30 | 80 | 4 | 35 | 350 | 1.34 | oil/gas | no pits |
| | | | | | | | 1.41 | water | no pits |
| Blank | 200 | 30 | 120 | 4 | 35 | 350 | 45.78 | oil/gas | pits |
| | | | | | | | 32.3 | water | pits |
| CE5 | 200 | 30 | 120 | 4 | 35 | 350 | 2.57 | oil/gas | no pits |
| | | | | | | | 47.97 | water | pits |
| E4 | 200 | 30 | 120 | 4 | 35 | 350 | 2.19 | oil/gas | no pits |
| | | | | | | | 2.57 | water | no pits |
| Blank | 200 | 30 | 120 | 10 | 35 | 350 | 32.12 | oil/gas | pits |
| | | | | | | | 32.61 | water | pits |
| E4 | 200 | 30 | 120 | 10 | 35 | 350 | 1.37 | oil/gas | no pits |
| | | | | | | | 3.04 | water | no pits |
| E5 | 200 | 30 | 120 | 10 | 35 | 350 | 53.92 | oil/gas | pits |
| | | | | | | | 31.94 | water | pits |
| E6 | 200 | 30 | 120 | 10 | 35 | 350 | 1.97 | oil/gas | no pits |
| | | | | | | | 4.19 | water | no pits |
| E7 | 200 | 30 | 120 | 10 | 35 | 350 | 1.9 | oil/gas | no pits |
| | | | | | | | 2.95 | water | pits |
| E8 | 200 | 30 | 120 | 10 | 35 | 350 | 1.25 | oil/gas | no pits |
| | | | | | | | 3.78 | water | no pits |

The addition of ammonium iodide, formic acid, and trans-cinnamaldehyde to CE1 and CE2 dropped the corrosion protection in the oil/gas phase by a factor of 10 to 20 as compared to CE5. CE5 is a blend of CE1 and CE2 and surfactants. E4 showed the best corrosion protection in both the water and gas phases and exhibits unique protection in the oil/gas phase not seen by conventional alkyl pyridine chemistry.

At 80° C. (176° F.), CE5 provided better corrosion protection than CE3 and CE4 in the oil/gas phase, once again demonstrating that the addition of ammonium iodide, formic acid, and trans-cinnamaldehyde to benzyl chloride quaternary of alkyl pyridines reduced corrosion protection.

Referring now to FIG. 4, the test results for 200 ppm of E4, 200 ppm of CE5, 200 ppm of CE3, and 200 ppm of CE4 at 50° C. (122° F.) in the presence of 88,600 ppm chlorides are shown. In oil/gas phase at 50° C. (122° F.), E4 worked better than any of the comparative examples CE3, CE4, and CE5.

Referring now to FIG. 5, the test results for 200 ppm of E4, 200 ppm of CE5, 200 ppm of CE3, and 200 ppm of CE4 at 80° C. (176° F.) in the presence of 88,600 ppm chlorides are shown. In both oil/gas phase and aqueous phase at 80° C. (176° F.), E4 worked better than any of the comparative examples CE3, CE4, and CE5.

Referring now to FIG. 6, the test results for 200 ppm of E4, 200 ppm of CE5, 200 ppm of CE3, and 200 ppm of CE4 at 120° C. (248° F.) in the presence of 88,600 ppm chlorides are shown. In the oil/gas phase at 120° C. (248° F.), E4 worked better than any of the comparative examples CE3 and CE4.

Once again demonstrating that the addition of ammonium iodide, formic acid and trans-cinnamaldehyde to benzyl chloride quaternary of alkyl pyridines reduced corrosion protection. C5 and E4 had similar protection in the oil and gas phase as shown in FIG. 7. E4 had better protection than CE5 in oil and gas phase and water phase at 50° C. and 120° C. E4 only had better protection than CE5 at 80° C. in the oil and gas phase.

Another feature of the corrosion protection provided by E4 as compared to CE5 is that E4 has no pits while CE5 has pits. In low salinity, the test conditions consisted of 35% H₂S, 4% CO₂ and 10,000 mg/L Chloride as shown in FIG. 7. E4 provided more protection across the board than CE5. CE5 failed because it has pitting across the temperature range, even though, in a few cases, it has lower corrosion rates.

As shown in FIG. 8, in high salinity, the test conditions consisted of 35% H₂S, 4% CO₂ and 88,600 mg/L chloride, once again, E4 provided better protection than CE5 at 120° C. (248° F.) and nearly equivalent protection at 80° C. (176° F.). E4 provided similar protection to CE5 in the oil/gas phase at 50° C. (122° F.). E4 provided about 30 times better protection than CE5 in the water phase at 50° C. (122° F.) and 20 times more protection at 120° C. (248° F.).

FIG. 9 shows the coupons treated with CE5 under low salinity conditions (10,000 mg/L chloride). E4 had superior protection compared to CE5 showing no pitting. The top three coupons are from the oil/gas phase and the bottom three coupons are from the water phase. Pitting was observed at all three temperatures in the water phase as shown by the arrows.

FIG. 10 shows the CE5 coupons after corrosion testing under high salinity conditions (88,600 mg/L chlorides). The top three coupons are from the oil/gas phase and the bottom three coupons are from the water phase. We can clearly see that CE5 exhibited visual pitting at 50° C. (122° F.) and 120° C. (248° F.) as shown by the arrows.

The results for each components performance in the E4 formulations indicate that we can formulate the product without formic acid and iodide. Main ingredient in the formulation is E2 and trans cinnamaldehyde. Without E2 formulation, water phase corrosion rate is similar to blank and gas phase is almost 54 mpy.

Referring now to FIG. 11, a comparison of non-alkyl pyridine corrosion inhibitors E4-E8 of this invention in a high salinity fluid (88,600 mg/L chloride).

Referring now to FIG. 12, an oil/gas phase and water phase coupons for non-alkyl pyridine corrosion inhibitors E4-E8 of this invention in a high salinity fluid (88,600 mg/L chloride).

Referring now to FIG. 13, a comparison of coupons for non-alkyl pyridine corrosion inhibitors E5 and E7 of this invention.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A compositions comprising:
a hydrogen sulfide corrosion system including:
at least one dialkyl sulfate quaternary salt of 1,2-disubstituted imidazoline, and
an intensifier system including:
low molecular weight carboxylic acids, unsaturated aldehydes, iodide compounds, bismuth-containing compounds, antimony-containing compounds, nitrates, copper-containing compounds, or mixtures and combinations thereof.

2. The composition of claim 1, wherein the corrosion system further includes dialkyl sulfate quaternary salts of 1,2-disubstituted imidazoline amides, bicyclic amines, amides of polyamines, polyamines, or mixtures and combinations thereof.

3. The composition of claim 1, wherein the corrosion system includes dialkyl sulfate quaternary salts of 1,2-disubstituted imidazolines, 1,2-disubstituted imidazoline amides, bicyclic amines, amides of polyamines, polyamines, or mixtures and combinations thereof.

4. The composition of claim 3, wherein the intensifier systems include mixtures of ammonium iodide, iodine, water, t-cinnamaldehyde, formic acid, or mixtures and combinations thereof.

5. The composition of claim 1, wherein the 1,2-disubstituted imidazolines are represented by compounds of Formula (I): 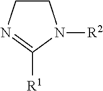
where R¹ is a saturated or unsaturated linear or branched alkyl group having 8 to 40 carbons, which may include a cyclic moiety, and R² is a hydroxyl (OH) terminated carbyl group having between 1 and 6 carbon atoms, an alkoxy (OR) terminated carbyl group having between 1 and 6 carbon atoms, or an amino (NR′R″) terminated carbyl group having between 1 and 6 carbon atoms, where R is a carbyl group having between 1 and 6 carbon atoms, R′ and R″ are a hydrogen atom or a carbyl group having between 1 and 6 carbon atoms.

6. The composition of claim 5, wherein the R² group is selected from the group consisting of —CH₂OH, —CH₂CH₂OH, —CH₂CH₂CH₂OH, —CH₂OCH₃, —CH₂CH₂OCH₃, —CH₂CH₂CH₂OCH₃, —CH₂NH₂, —CH₂CH₂NH₂, —CH₂CH₂CH₂NH₂, and mixtures or combinations thereof.

7. A method for inhibiting corrosion at low temperature comprising:
treating a surface with an effective amount of a composition including:
a hydrogen sulfide corrosion system including:
at least one dialkyl sulfate quaternary salt of 1,2-disubstituted imidazoline, and
an intensifier system including:
low molecular weight carboxylic acids, unsaturated aldehydes, iodide compounds, bismuth-containing compounds, antimony-containing compounds, nitrates, copper-containing compounds, or mixtures and combinations thereof.

8. The method of claim 7, wherein the corrosion system further includes dialkyl sulfate quaternary salts of 1,2-disubstituted imidazoline amides, bicyclic amines, amides of polyamines, polyamines, or mixtures and combinations thereof.

9. The method of claim 7, wherein the corrosion system includes dialkyl sulfate quaternary salts of 1,2-disubstituted imidazolines, 1,2-disubstituted imidazoline amides, bicyclic amines, amides of polyamines, polyamines, or mixtures and combinations thereof.

10. The method of claim 9, wherein the intensifier systems include mixtures of ammonium iodide, iodine, water, t-cinnamaldehyde, formic acid, or mixtures and combinations thereof.

11. The method of claim 7, wherein the 1,2-disubstituted imidazolines are represented by compounds of Formula (I): 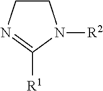
where R¹ is a saturated or unsaturated linear or branched alkyl group having 8 to 40 carbons, which may include a cyclic moiety, and R² is a hydroxyl (OH) terminated carbyl group having between 1 and 6 carbon atoms, an alkoxy (OR) terminated carbyl group having between 1 and 6 carbon atoms, or an amino (NR′R″) terminated carbyl group having between 1 and 6 carbon atoms, where R is a carbyl group having between 1 and 6 carbon atoms, R′ and R″ are a hydrogen atom or a carbyl group having between 1 and 6 carbon atoms.

12. The method of claim 11, wherein the R² group is selected from the group consisting of —CH₂OH, —CH₂CH₂OH, —CH₂CH₂CH₂OH, —CH₂OCH₃, —CH₂CH₂OCH₃, —CH₂CH₂CH₂OCH₃, —CH₂NH₂, —CH₂CH₂NH₂, —CH₂CH₂CH₂NH₂, and mixtures or combinations thereof.

13. A composition comprising:
a base fluid including an effective amount of:
a hydrogen sulfide corrosion system including:
at least one dialkyl sulfate quaternary salt of 1,2-disubstituted imidazoline, and
an intensifier system including:
low molecular weight carboxylic acids, unsaturated aldehydes, iodide compounds, bismuth-containing compounds, antimony-containing compounds, nitrates, copper-containing compounds, or mixtures and combinations thereof.

14. The composition of claim 13, wherein the corrosion system further includes dialkyl sulfate quaternary salts of 1,2-disubstituted imidazoline amides, bicyclic amines, amides of polyamines, polyamines, or mixtures and combinations thereof.

15. The composition of claim 13, wherein the corrosion system includes dialkyl sulfate quaternary salts of 1,2-disubstituted imidazolines, 1,2-disubstituted imidazoline amides, bicyclic amines, amides of polyamines, polyamines, or mixtures and combinations thereof.

16. The composition of claim 15, wherein the intensifier systems include mixtures of ammonium iodide, iodine, water, t-cinnamaldehyde, formic acid, or mixtures and combinations thereof.

17. The composition of claim 13, wherein the 1,2-disubstituted imidazolines are represented by compounds of Formula (I): 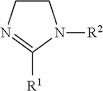
where R¹ is a saturated or unsaturated linear or branched alkyl group having 8 to 40 carbons, which may include a cyclic moiety, and R² is a hydroxyl (OH) terminated carbyl group having between 1 and 6 carbon atoms, an alkoxy (OR) terminated carbyl group having between 1 and 6 carbon atoms, or an amino (NR′R″) terminated carbyl group having between 1 and 6 carbon atoms, where R is a carbyl group having between 1 and 6 carbon atoms, R′ and R″ are a hydrogen atom or a carbyl group having between 1 and 6 carbon atoms.

18. The composition of claim 17, wherein the R² group is selected from the group consisting of —CH₂OH, —CH₂CH₂OH, —CH₂CH₂CH₂OH, —CH₂OCH₃, —CH₂CH₂OCH₃, —CH₂CH₂CH₂OCH₃, —CH₂NH₂, —CH₂CH₂NH₂, —CH₂CH₂CH₂NH₂, and mixtures or combinations thereof.

19. A method of drilling and producing comprising:
circulating a drilling fluid in a well during drilling, where the drilling fluid includes:
a hydrogen sulfide corrosion system including:
at least one dialkyl sulfate quaternary salt of 1,2-disubstituted imidazoline, and
an intensifier system including:
low molecular weight carboxylic acids, unsaturated aldehydes, iodide compounds, bismuth-containing compounds, antimony-containing compounds, nitrates, copper-containing compounds, or mixtures and combinations thereof.

20. The method of claim 19, wherein the corrosion system further includes dialkyl sulfate quaternary salts of 1,2-disubstituted imidazoline amides, bicyclic amines, amides of polyamines, polyamines, or mixtures and combinations thereof.

21. The method of claim 19, wherein the corrosion system includes dialkyl sulfate quaternary salts of 1,2-disubstituted imidazolines, 1,2-disubstituted imidazoline amides, bicyclic amines, amides of polyamines, polyamines, or mixtures and combinations thereof.

22. The method of claim 21, wherein the intensifier systems include mixtures of ammonium iodide, iodine, water, t-cinnamaldehyde, formic acid, or mixtures and combinations thereof.

23. The method of claim 19, wherein the 1,2-disubstituted imidazolines are represented by compounds of Formula (I): 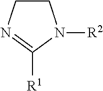
where R¹ is a saturated or unsaturated linear or branched alkyl group having 8 to 40 carbons, which may include a cyclic moiety, and R² is a hydroxyl (OH) terminated carbyl group having between 1 and 6 carbon atoms, an alkoxy (OR) terminated carbyl group having between 1 and 6 carbon atoms, or an amino (NR′R″) terminated carbyl group having between 1 and 6 carbon atoms, where R is a carbyl group having between 1 and 6 carbon atoms, R′ and R″ are a hydrogen atom or a carbyl group having between 1 and 6 carbon atoms.

24. The method of claim 23, wherein the R² group is selected from the group consisting of —CH₂OH, —CH₂CH₂OH, —CH₂CH₂CH₂OH, —CH₂OCH₃, —CH₂CH₂OCH₃, —CH₂CH₂CH₂OCH₃, —CH₂NH₂, —CH₂CH₂NH₂, —CH₂CH₂CH₂NH₂, and mixtures or combinations thereof.
